(19) United States
(12) Patent Application Publication
(10) Pub. No.: US 2022/0073112 A1
(43) Pub. Date: Mar. 10, 2022

(54) IMAGING DISTURBANCE DETECTION DEVICE, IMAGING DISTURBANCE DETECTION SYSTEM, AND IMAGING DISTURBANCE DETECTION METHOD

(71) Applicant: Mitsubishi Electric Corporation, Tokyo (JP)

(72) Inventors: Kosei OKETA, Tokyo (JP); Hitoshi YOMOGIDA, Tokyo (JP); Naoya FUKUOKA, Tokyo (JP)

(73) Assignee: Mitsubishi Electric Corporation, Tokyo (JP)

(21) Appl. No.: 17/417,763

(22) PCT Filed: Sep. 18, 2019
(86) PCT No.: PCT/JP2019/036585

§ 371 Date: Jun. 24, 2021

(30) Foreign Application Priority Data
Feb. 4, 2019 (JP) 2019-017894

(51) Int. Cl. B61D 49/00; H04N 5/225; H04N 5/232; G08B 13/196

(52) U.S. Cl. CPC B61D 49/00; H04N 5/2257; G08B 13/19604; H04N 5/23222; H04N 5/23229

(57) ABSTRACT

An imaging disturbance detection device includes an estimation information obtaining unit that obtains pieces of disturbance estimation information indicating whether or not there is imaging disturbance on each of a plurality of imaging devices installed on a railroad car, which is estimated by comparing luminance of images taken by the imaging devices with predetermined reference luminance set; and a disturbance identifying unit that identifies, when it is estimated, on the basis of the obtained pieces of disturbance estimation information, that there is imaging disturbance on a first imaging device, whether or not there is imaging disturbance on a first imaging device on the basis of which one, presence or absence of imaging disturbance, is estimated for a second imaging device, and a length of a period during which it is continuously estimated that there is imaging disturbance on the first imaging device.

### TECHNICAL FIELD

The invention relates to an imaging disturbance detection device, an imaging disturbance detection system, and an imaging disturbance detection method.

### BACKGROUND ART

There is a technique for determining whether or not an imaging device is subjected to imaging disturbance.

For example, Patent Literature 1 discloses an imaging disturbance detection device that detects disturbance in imaging performed by a camera for each machine provided in an amusement arcade on the basis of image information captured by the camera for each machine, and includes imaging disturbance determining means for determining disturbance in imaging performed by the camera for each machine on the basis of image information indicating information obtained by converting the amount of light entering the camera for each machine into numbers, and when numerical information indicated by the image information is included in a specific threshold range, the imaging disturbance determining means determines that it is a first state indicating that there is a possibility of undergoing imaging disturbance, and when the first state continues for a predetermined time, the imaging disturbance determining means determines that it is a second state in which the possibility of undergoing imaging disturbance is higher than the first state.

### CITATION LIST

### Patent Literature

Patent Literature 1: JP 2014-223135 A

### SUMMARY OF INVENTION

### Technical Problem

A railroad company installs a plurality of imaging devices on the inside of a railroad car and records images taken by the plurality of imaging devices in order to prevent crime in the railroad car or improve passenger services, etc. The railroad company owns many cars. Hence, it requires a tremendous amount of time for the railroad company to perform, for a plurality of imaging devices installed on many cars owned, a human inspection or check as to whether or not an imaging abnormality has occurred due to, for example, covering of an optical system such as a lens part of an imaging device by a cloth, etc. In addition, inspection or check operations on a plurality of imaging devices installed on a railroad car that is operated in normal times by the railroad company is limited to a period during which the railroad car is housed in a train depot outside operating hours, or when a regular inspection which is performed every predetermined period is performed. Hence, it takes time for the railroad company to find an imaging abnormality, and there is a possibility that a state in which there is an imaging abnormality may not be able to be recovered to a state in which normal imaging can be performed, over a long period of time. An incident, an accident, or the like, occurring in a railroad car in an imaging abnormal state is not recorded in a normal image, and thus, there is a problem that a situation, etc., upon the occurrence of the incident, accident, or the like, may not be able to be checked later on.

For example, when a railroad car is on standby in an underground train depot over a long period of time, there are no passengers on the railroad car and the railroad car is in a constant illumination environment by in-car lighting of the railroad car, and thus, there is no change in the average value of luminance of an imaging device. Thus, when the imaging disturbance detection device disclosed in Patent Literature 1 is applied to a railroad car, the imaging disturbance detection device may, for example, erroneously determine that a standby state of the railroad car such as that described above is an imaging abnormal state despite the fact that an imaging device is in a normal state.

The invention is made to solve the above-described problem, and an object of the invention is to provide an imaging disturbance detection device that can accurately determine whether or not an imaging device installed in a railroad car is in an imaging abnormal state.

### Solution to Problem

An imaging disturbance detection device according to the invention includes an estimation information obtaining unit for obtaining pieces of disturbance estimation information indicating whether or not there is imaging disturbance on each of a plurality of imaging devices installed on inside of a railroad car, an estimation as to whether or not there is imaging disturbance on each of the plurality of imaging devices being made by comparing luminance of each of images taken by the plurality of imaging devices with predetermined reference luminance set for each of the plurality of imaging devices; a disturbance identifying unit for identifying, when it is estimated, on the basis of the pieces of disturbance estimation information of the respective plurality of imaging devices obtained by the estimation information obtaining unit, that there is imaging disturbance on a first imaging device among the plurality of imaging devices, whether or not there is imaging disturbance on the first imaging device on the basis of whether or not there is imaging disturbance on a second imaging device different from the first imaging device among the plurality of imaging devices, and a length of a period during which it is continuously estimated that there is imaging disturbance on the first imaging device; and an output control unit for outputting an identifying display signal for identifying the first imaging device identified by the disturbance identifying unit to have imaging disturbance.

### Advantageous Effects of Invention

According to the invention, a determination as to whether or not an imaging device installed in a railroad car is in an imaging abnormal state can be accurately made.

### BRIEF DESCRIPTION OF DRAWINGS

FIG. 1 is an arrangement diagram showing an example of arrangement of main parts of an imaging disturbance detection system according to a first embodiment as viewed from the top of a railroad car.

FIG. 2 is a configuration diagram showing an example of a system configuration of the imaging disturbance detection system according to the first embodiment.

FIGS. 3A, 3B, 3C, and 3D are cross-sectional views showing examples of cross-sections Ya1-Ya2, Yb1-Yb2, Yc1-Yc2, and Yd1-Yd2, respectively, when the inside of the railroad car is viewed in a direction of an arrow X shown in FIG. 1.

FIG. 4 is a diagram showing an example of areas inside the railroad car taken by imaging devices shown in FIGS. 1 and 3.

FIGS. 5A, 5B, 5C, and 5D are diagrams showing examples of images taken by the imaging devices shown in FIG. 4.

FIG. 6 is a block diagram showing an example of a configuration of main parts of an imaging disturbance detection device in the imaging disturbance detection system according to the first embodiment.

FIG. 7A is a diagram showing an example of a case in which a disturbance identifying unit according to the first embodiment identifies that there is no imaging disturbance on a given imaging device, and FIG. 7B is a diagram showing an example of a case in which the disturbance identifying unit according to the first embodiment identifies that there is imaging disturbance on a given imaging device.

FIG. 8 is a diagram showing an example of the presence or absence of imaging disturbance estimated for the imaging devices shown in FIG. 1 and the presence or absence of imaging disturbance identified by the disturbance identifying unit according to the first embodiment.

FIGS. 9A and 9B are diagrams showing examples of a hardware configuration of the imaging disturbance detection device 100 in the imaging disturbance detection system 1 according to the first embodiment.

FIG. 10 is a flowchart that describes an example of processes performed by the imaging disturbance detection device in the imaging disturbance detection system according to the first embodiment.

FIG. 11 is a block diagram showing an example of a configuration of main parts of an imaging disturbance detection device in an imaging disturbance detection system according to a second embodiment.

FIG. 12 is a flowchart that describes an example of processes performed by the imaging disturbance detection device in the imaging disturbance detection system according to the second embodiment.

FIG. 13 is a block diagram showing an example of a configuration of main parts of an imaging disturbance detection device in an imaging disturbance detection system according to a third embodiment.

FIG. 14A is a flowchart that describes an example of processes performed by the imaging disturbance detection device in the imaging disturbance detection system according to the third embodiment.

FIG. 14B is a flowchart that describes an example of processes performed by the imaging disturbance detection device in the imaging disturbance detection system according to the third embodiment.

FIG. 15 is a block diagram showing an example of a configuration of main parts of an imaging disturbance detection device in an imaging disturbance detection system according to a fourth embodiment.

FIG. 16A is a flowchart that describes an example of processes performed by the imaging disturbance detection device in the imaging disturbance detection system according to the fourth embodiment.

FIG. 16B is a flowchart that describes an example of processes performed by the imaging disturbance detection device in the imaging disturbance detection system according to the fourth embodiment.

### DESCRIPTION OF EMBODIMENTS

Embodiments of the invention will be described in detail below with reference to the drawings.

### First Embodiment

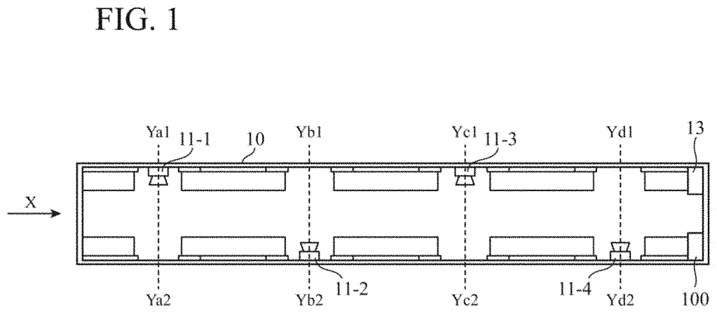

FIG. 1 is an arrangement diagram showing an example of arrangement of main parts of an imaging disturbance detection system 1 according to a first embodiment as viewed from the top of a railroad car 10.

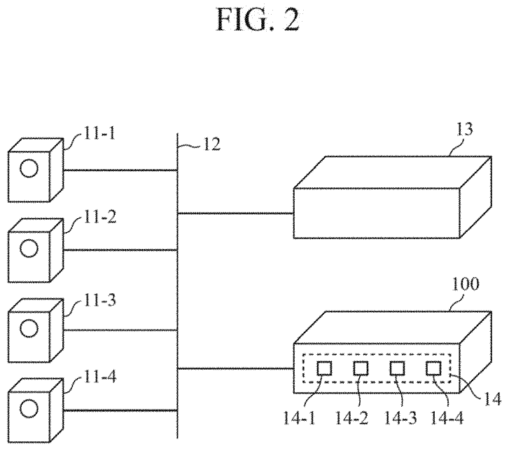

FIG. 2 is a configuration diagram showing an example of a system configuration of the imaging disturbance detection system 1 according to the first embodiment.

The imaging disturbance detection system 1 includes, as main parts, the railroad car 10, a plurality of imaging devices 11-1, 11-2, . . . , 11-N (N is a natural number), a communication network 12, a display device 14, and an imaging disturbance detection device 100. In addition to the above-described components, the imaging disturbance detection system 1 may include an image recording device 13.

The imaging devices 11-1, 11-2, . . . , 11-N are, for example, image input devices that can output, as image information, an image taken by a digital still camera, a digital video camera, or the like, to an external source. The imaging devices 11-1, 11-2, . . . , 11-N are installed on the inside of the railroad car 10 and take an image of the inside of the railroad car 10. Description is made assuming that in the imaging disturbance detection system 1 according to the first embodiment, as an example, four imaging devices 11-1, 11-2, 11-3, and 11-4 are installed on the railroad car 10 as the imaging devices 11-1, 11-2, . . . , 11-N. The number of the imaging devices 11-1, 11-2, . . . , 11-N included in the imaging disturbance detection system 1 may be three or less or five or more as long as the number is plural.

The imaging devices 11-1, 11-2, . . . , 11-N output image information to an external source through the communication network 12 such as a local area network (LAN) or a wireless LAN.

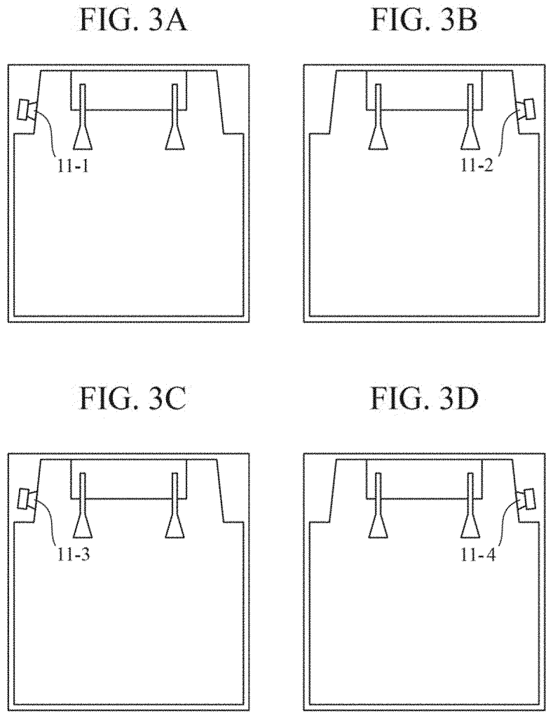

FIGS. 3A, 3B, 3C, and 3D are cross-sectional views showing examples of cross-sections Ya1-Ya2, Yb1-Yb2, Yc1-Yc2, and Yd1-Yd2, respectively, when the inside of the railroad car 10 is viewed in a direction of an arrow X of FIG. 1.

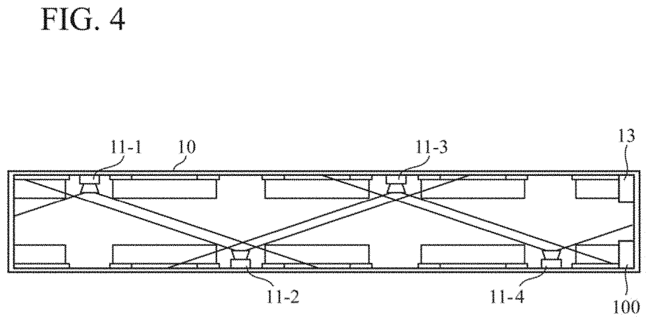

FIG. 4 is a diagram showing an example of areas inside the railroad car 10 taken by the imaging devices 11-1, 11-2, 11-3, and 11-4.

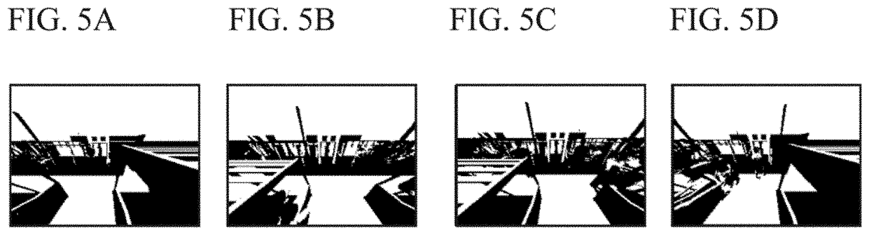

FIGS. 5A, 5B, 5C, and 5D are diagrams showing examples of images taken by the imaging devices 11-1, 11-2, 11-3, and 11-4, respectively.

As can be seen from the diagrams of FIGS. 3 to 5, the imaging devices 11-1, 11-2, 11-3, and 11-4 are staggered at the top of doors through which passengers come and go when getting on and off so that the imaging devices 11-1, 11-2, 11-3, and 11-4 can take an image of the inside of the entire railroad car 10.

The image recording device 13 obtains pieces of image information outputted from the imaging devices 11-1, 11-2, . . . , 11-N, and records the obtained pieces of image information in a nonvolatile storage medium, etc., included in the image recording device 13 in such a manner that the obtained pieces of image information are associated with pieces of identification information for identifying the imaging devices 11-1, 11-2, . . . , 11-N and pieces of obtainment time information indicating times at which the pieces of image information are obtained. Specifically, for example, the image recording device 13 obtains, through the communication network 12, pieces of image information outputted from the imaging devices 11-1, 11-2, . . . , 11-N.

An installation location of the image recording device 13 is not limited to the inside of the railroad car 10 as long as the image recording device 13 can obtain, through the communication network 12, pieces of image information outputted from the imaging devices 11-1, 11-2, . . . , 11-N, and may be installed, for example, at a location away from the railroad car 10. In the first embodiment, description is made assuming that the image recording device 13 is installed on the inside of the railroad car 10.

The imaging disturbance detection device 100 identifies whether or not there is imaging disturbance on the imaging devices 11-1, 11-2, . . . , 11-N, on the basis of pieces of disturbance estimation information indicating whether or not there is imaging disturbance on the imaging devices 11-1, 11-2, . . . , 11-N which is estimated by comparing luminance of images indicated by pieces of image information outputted from the imaging devices 11-1, 11-2, . . . , 11-N with reference luminance determined in advance for the imaging devices 11-1, 11-2, . . . , 11-N, and outputs an identifying display signal for identifying any of the imaging devices 11-1, 11-2, . . . , 11-N that is identified to have imaging disturbance.

Note that the luminance of an image indicated by image information is, for example, the average value of luminance of the entire image.

The display device 14 displays an identifying display signal outputted from the imaging disturbance detection device 100. The display device 14 includes, for example, a plurality of light-emitting elements such as light-emitting diodes or lamps that correspond to the respective imaging devices 11-1, 11-2, . . . , 11-N. When the display device 14 includes a plurality of light-emitting elements, the imaging disturbance detection device 100 controls light emission of each light-emitting element by outputting an identifying display signal.

The display device 14 is not limited to one including light-emitting elements.

For example, the display device 14 may be a display such as a liquid crystal display. When the display device 14 is a display, the imaging disturbance detection device 100 outputs, as an identifying display signal, an image for identifying any of the imaging devices 11-1, 11-2, . . . , 11-N that is identified to have imaging disturbance, and controls display of the display.

In addition, for example, the display device 14 may be an audio output device such as a speaker or a buzzer. When the display device 14 is an audio output device, the imaging disturbance detection device 100 performs notification control for audio notification by outputting an identifying display signal to the audio output device.

In addition, for example, the display device 14 may display an image signal outputted from an external device such as a computing machine which is not shown. When the display device 14 displays an image signal outputted from an external device, the imaging disturbance detection device 100 outputs, as identifying display signals, pieces of identification information for identifying the imaging devices 11-1, 11-2, . . . , 11-N to the external device through the communication network 12, and the external device generates image signals on the basis of the pieces of identification information obtained from the imaging disturbance detection device 100, and outputs the image signals to the display device 14.

In the first embodiment, description is made assuming that as shown in FIG. 2, the display device 14 includes light-emitting elements 14-1, 14-2, 14-3, and 14-4 corresponding to the imaging devices 11-1, 11-2, 11-3, and 11-4, respectively, and arranged in a casing of the imaging disturbance detection device 100, and the imaging disturbance detection device 100 controls light emission of the light-emitting elements 14-1, 14-2, 14-3, and 14-4 by outputting identifying display signals.

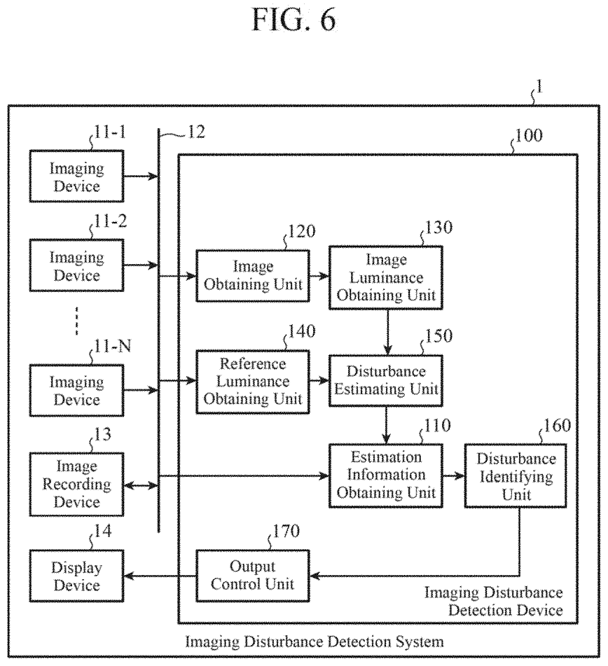

FIG. 6 is a block diagram showing an example of a configuration of main parts of the imaging disturbance detection device 100 in the imaging disturbance detection system 1 according to the first embodiment.

The imaging disturbance detection device 100 includes an estimation information obtaining unit 110, an image obtaining unit 120, an image luminance obtaining unit 130, a reference luminance obtaining unit 140, a disturbance estimating unit 150, a disturbance identifying unit 160, and an output control unit 170.

The image obtaining unit 120 obtains, through the communication network 12, pieces of image information outputted from the imaging devices 11-1, 11-2, . . . , 11-N. The image obtaining unit 120 may obtain pieces of image information outputted from the imaging devices 11-1, 11-2, . . . , 11-N by obtaining pieces of image information recorded in the image recording device 13 through the communication network 12.

The image luminance obtaining unit 130 obtains pieces of image luminance information indicating luminance of each of images taken by the imaging devices 11-1, 11-2, . . . , 11-N.

The image luminance obtaining unit 130 calculates, using image information outputted from each of the imaging devices 11-1, 11-2, . . . , 11-N and obtained by the image obtaining unit 120, the average value of luminance of an image indicated by the image information, thereby generating and obtaining image luminance information indicating luminance of the image.

The image luminance obtaining unit 130 may obtain pieces of image luminance information indicating luminance of each of images taken by the imaging devices 11-1, 11-2, . . . , 11-N, from the imaging devices 11-1, 11-2, . . . , 11-N or the image recording device 13 through the communication network 12.

The reference luminance obtaining unit 140 obtains pieces of reference luminance information indicating predetermined reference luminance set for each of the plurality of imaging devices 11-1, 11-2, . . . , 11-N.

For example, the reference luminance obtaining unit 140 obtains pieces of reference luminance information from the imaging devices 11-1, 11-2, . . . , 11-N or the image recording device 13 through the communication network 12.

The reference luminance obtaining unit 140 may obtain reference luminance information by reading the reference luminance information from a storage device (not shown) provided inside or outside the casing of the imaging disturbance detection device 100.

The disturbance estimating unit 150 estimates whether or not there is imaging disturbance on the imaging devices 11-1, 11-2, . . . , 11-N by comparing the luminance of each of the images indicated by the pieces of image luminance information obtained by the image luminance obtaining unit 130 with the predetermined reference luminance set for each of the plurality of imaging devices 11-1, 11-2, . . . , 11-N and indicated by the pieces of reference luminance information obtained by the reference luminance obtaining unit 140. The disturbance estimating unit 150 generates pieces of disturbance estimation information indicating whether or not there is imaging disturbance on the imaging devices 11-1, 11-2, . . . , 11-N which is estimated thereby.

Upon estimating whether or not there is imaging disturbance, the disturbance estimating unit 150 may use the average value of luminance of all images indicated by the pieces of image luminance information obtained by the image luminance obtaining unit 130, instead of predetermined reference luminance set for each of the plurality of imaging devices 11-1, 11-2, . . . , 11-N and indicated by the pieces of reference luminance information obtained by the reference luminance obtaining unit 140.

For example, when an optical system such as a lens of any of the imaging devices 11-1, 11-2, . . . , 11-N is covered by a light-shielding cloth, etc., luminance of an image taken by the imaging device has a lower value than reference luminance of the imaging device. When luminance of a given image is lower than reference luminance of an imaging device having taken the image as a result of a comparison between the luminance and the reference luminance, disturbance estimation information indicates that it is estimated that there is imaging disturbance on the imaging device.

In addition, for example, when an optical system of any of the imaging devices 11-1, 11-2, . . . , 11-N is externally irradiated with intense white light, etc., luminance of an image taken by the imaging device has a higher value than reference luminance of the imaging device. When luminance of a given image is higher than reference luminance of an imaging device having taken the image as a result of a comparison between the luminance and the reference luminance, disturbance estimation information may indicate that it is estimated that there is imaging disturbance on the imaging device.

In addition, when luminance of a given image has a value in a range determined in advance for reference luminance of an imaging device having taken the image, as a result of a comparison between the luminance and the reference luminance, disturbance estimation information may indicate that it is estimated that there is no imaging disturbance on the imaging device, and when the luminance has a value outside the range determined in advance for the reference luminance, disturbance estimation information may indicate that it is estimated that there is imaging disturbance on the imaging device.

In the first embodiment, as an example, description is made assuming that when luminance of a given image is lower than reference luminance of an imaging device having taken the image as a result of a comparison between the luminance and the reference luminance, disturbance estimation information indicates that it is estimated that there is imaging disturbance on the imaging device.

The estimation information obtaining unit 110 obtains the pieces of disturbance estimation information generated by the disturbance estimating unit 150.

By the imaging disturbance detection device 100 thus including the image obtaining unit 120, the image luminance obtaining unit 130, the reference luminance obtaining unit 140, and the disturbance estimating unit 150, even when the already installed imaging devices 11-1, 11-2, . . . , 11-N and image recording device 13 cannot generate disturbance estimation information, the imaging disturbance detection system 1 can be constructed.

The estimation information obtaining unit 110 may obtain pieces of disturbance estimation information generated by the imaging devices 11-1, 11-2, . . . , 11-N from the imaging devices 11-1, 11-2, . . . , 11-N. The imaging devices 11-1, 11-2, . . . , 11-N estimate whether or not there is imaging disturbance on their imaging devices 11-1, 11-2, . . . , 11-N by comparing luminance of each of images taken by the imaging devices 11-1, 11-2, . . . , 11-N with predetermined reference luminance set for each of the imaging devices 11-1, 11-2, . . . , 11-N. The imaging devices 11-1, 11-2, . . . , 11-N generate pieces of disturbance estimation information indicating whether or not there is imaging disturbance, on the basis of results of the estimation made by the imaging devices 11-1, 11-2, . . . , 11-N. The imaging devices 11-1, 11-2, . . . , 11-N outputs the generated pieces of disturbance estimation information to the imaging disturbance detection device 100 through the communication network 12.

By the imaging devices 11-1, 11-2, . . . , 11-N thus generating disturbance estimation information, a processing load on the imaging disturbance detection device 100 can be reduced.

In addition, the estimation information obtaining unit 110 may obtain disturbance estimation information generated by the image recording device 13 from the image recording device 13. The image recording device 13 generates pieces of disturbance estimation information by calculating luminance of each of images indicated by pieces of image information obtained from the imaging devices 11-1, 11-2, . . . , 11-N, on the basis of the pieces of image information, and comparing the luminance with reference luminance set for each of the imaging devices 11-1, 11-2, . . . , 11-N. The image recording device 13 outputs the generated pieces of disturbance estimation information to the imaging disturbance detection device 100 through the communication network 12.

By the image recording device 13 thus generating disturbance estimation information, a processing load on the imaging disturbance detection device 100 can be reduced. In addition, by the image recording device 13 generating disturbance estimation information, even when the already installed imaging devices 11-1, 11-2, . . . , 11-N cannot generate disturbance estimation information, the imaging disturbance detection system 1 can be constructed.

Note that when the estimation information obtaining unit 110 obtains disturbance estimation information generated by the imaging devices 11-1, 11-2, . . . , 11-N or the image recording device 13, in the imaging disturbance detection device 100, the image obtaining unit 120, the image luminance obtaining unit 130, the reference luminance obtaining unit 140, and the disturbance estimating unit 150 are not essential components.

The disturbance identifying unit 160 checks which one, the presence or absence of imaging disturbance, is estimated for each of the plurality of imaging devices 11-1, 11-2, . . . , 11-N, on the basis of the pieces of disturbance estimation information of the respective plurality of imaging devices 11-1, 11-2, . . . , 11-N obtained by the estimation information obtaining unit 110. For example, when it is estimated that there is imaging disturbance on a given imaging device (hereinafter, referred to as “first imaging device”) among the plurality of imaging devices 11-1, 11-2, . . . , 11-N, the presence or absence of imaging disturbance is identified for the first imaging device on the basis of which one, the presence or absence of imaging disturbance, is estimated for an imaging device (hereinafter, referred to as “second imaging device”) different from the first imaging device among the plurality of imaging devices 11-1, 11-2, . . . , 11-N, and the length of a period during which it is continuously estimated that there is imaging disturbance on the first imaging device.

Specifically, for example, when it is estimated that there is imaging disturbance on the imaging device 11-1 and it is estimated that there is imaging disturbance on all imaging devices 11-2, . . . , 11-N, the disturbance identifying unit 160 identifies that there is no imaging disturbance on the imaging device 11-1.

This identification is made because it is assumed, for example, that the illumination of the inside of the entire railroad car is insufficient, e.g., when the railroad car 10 having the imaging devices 11-1, . . . , 11-N installed therein is housed in a train depot.

In addition, for example, when it is estimated that there is imaging disturbance on the imaging device 11-1 and it is estimated that any of the imaging devices 11-2, . . . , 11-N has no imaging disturbance, the disturbance identifying unit 160 measures the length of a period during which it is continuously estimated that there is imaging disturbance on the imaging device 11-1. For the length of a period during which it is continuously estimated that there is imaging disturbance on the imaging device 11-1, a period from when it is estimated for the first time that there is imaging disturbance on the imaging device 11-1 to when it is continuously estimated that there is imaging disturbance on the imaging device 11-1 is measured, for example, by the disturbance identifying unit 160 using a timer which is not shown.

When the length of a period during which it is continuously estimated by the disturbance identifying unit 160 that there is imaging disturbance on the imaging device 11-1 is shorter than the length of a predetermined period, the disturbance identifying unit 160 identifies that there is no imaging disturbance on the imaging device 11-1.

This identification is made because it is assumed that the optical system of the imaging device 11-1 is temporarily covered, e.g., when the optical system of the imaging device 11-1 is accidentally covered by baggage of a passenger or the like who gets on the railroad car 10.

When the length of a period during which it is continuously estimated by the disturbance identifying unit 160 that there is imaging disturbance on the imaging device 11-1 is longer than the length of the predetermined period, the disturbance identifying unit 160 identifies that there is imaging disturbance on the imaging device 11-1.

This identification is made because it is assumed that the optical system of the imaging device 11-1 is continuously covered.

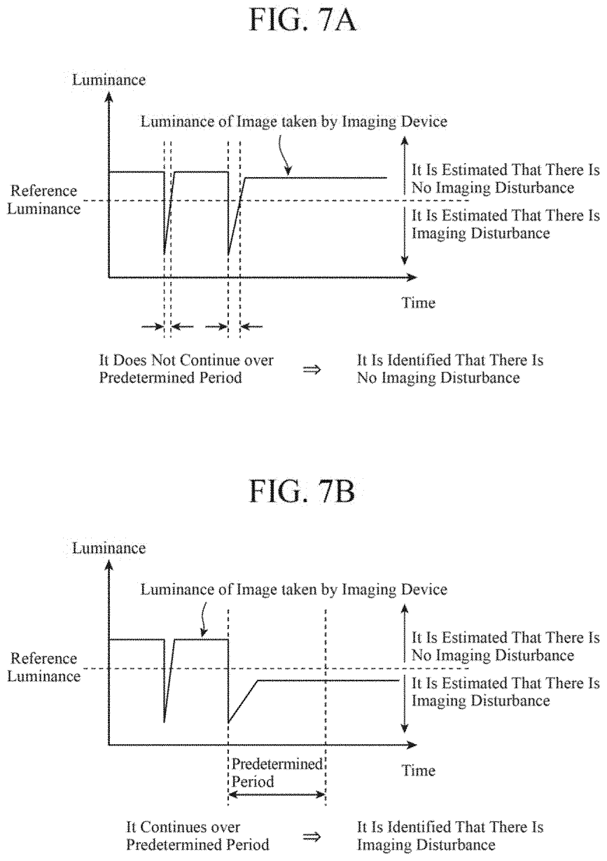

The length of a period during which it is continuously estimated that there is imaging disturbance on the imaging device 11-1 which is determined when the disturbance identifying unit 160 identifies whether or not there is imaging disturbance on the imaging device 11-1 will be described with reference to FIG. 7.

FIG. 7A is a diagram showing an example of a case in which the disturbance identifying unit 160 identifies that there is no imaging disturbance on a given imaging device.

FIG. 7B is a diagram showing an example of a case in which the disturbance identifying unit 160 identifies that there is imaging disturbance on a given imaging device.

In FIGS. 7A and 7B, a horizontal axis is time and a vertical axis is the level of luminance. A polygonal line represented by a solid line is luminance of an image taken by a given imaging device. A straight line represented by a broken line is reference luminance of the imaging device.

When, as shown in FIG. 7A, luminance of an image taken by a given imaging device is lower than reference luminance of the imaging device, but the luminance is not continuously low over a predetermined period which is determined in advance, the disturbance identifying unit 160 identifies that there is no imaging disturbance on the imaging device.

In addition, when, as shown in FIG. 7B, luminance of an image taken by a given imaging device is continuously lower than reference luminance of the imaging device over a predetermined period which is determined in advance, the disturbance identifying unit 160 identifies that there is imaging disturbance on the imaging device.

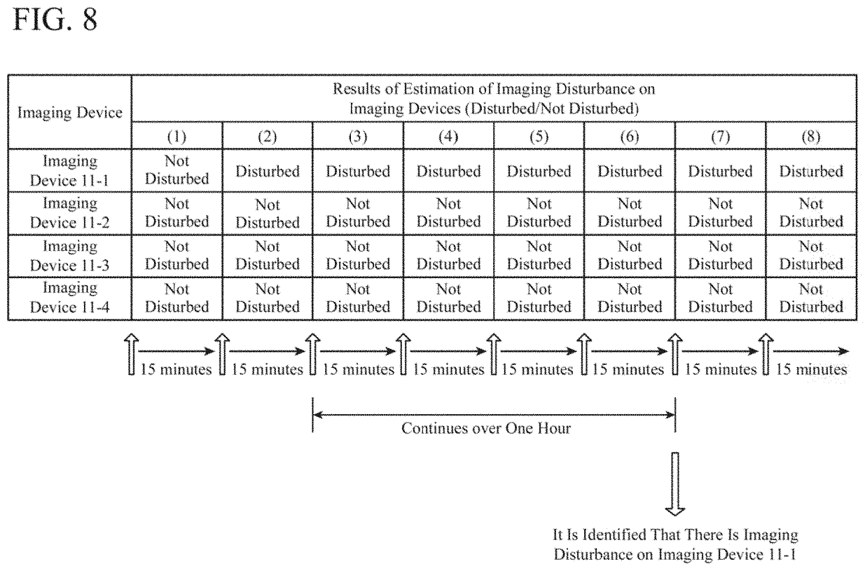

A method of identifying by the disturbance identifying unit 160 whether or not there is imaging disturbance on the basis of disturbance estimation information obtained by the estimation information obtaining unit 110 will be described with reference to FIG. 8.

FIG. 8 is a diagram showing an example of the presence or absence of imaging disturbance estimated for the four imaging devices 11-1, 11-2, 11-3, and 11-4 shown in FIG. 1 and the presence or absence of imaging disturbance identified by the disturbance identifying unit 160.

At a point in time indicated by (1) of FIG. 8, it is estimated that there is no imaging disturbance on all four imaging devices 11-1, 11-2, 11-3, and 11-4.

FIG. 8 shows an example in which the estimation information obtaining unit 110 obtains pieces of disturbance estimation information of the respective four imaging devices 11-1, 11-2, 11-3, and 11-4 at intervals of 15 minutes after the point in time indicated by (1), and the disturbance identifying unit 160 identifies whether or not there is imaging disturbance on the basis of the pieces of disturbance estimation information obtained by the estimation information obtaining unit 110.

At points in time indicated by (2) to (8) of FIG. 8, it is estimated that there is imaging disturbance on the imaging device 11-1 among the four imaging devices 11-1, 11-2, 11-3, and 11-4, and it is estimated that there is no imaging disturbance on imaging devices other than the imaging device 11-1.

FIG. 8 shows an example in which when it is continuously estimated that there is imaging disturbance on the imaging device 11-1 over one hour which is a predetermined period, the disturbance identifying unit 160 identifies that there is imaging disturbance on the imaging device 11-1.

The output control unit 170 outputs an identifying display signal for identifying any of the imaging devices 11-1, 11-2, . . . , 11-N that is identified by the disturbance identifying unit 160 to have imaging disturbance. Specifically, for example, the output control unit 170 outputs the identifying display signal to the display device 14.

When the disturbance identifying unit 160 identifies that there is no imaging disturbance on the imaging devices 11-1, 11-2, . . . , 11-N, the output control unit 170 may output identifying display signals for identifying the imaging devices 11-1, 11-2, . . . , 11-N that are identified to have no imaging disturbance.

For example, when, as shown in FIG. 2, the display device 14 includes the light-emitting elements 14-1, 14-2, 14-3, and 14-4 corresponding to the imaging devices 11-1, 11-2, 11-3, and 11-4, respectively, the output control unit 170 performs output control in such a manner that a light-emitting element corresponding to an imaging device that is identified to have no imaging disturbance is turned off, and a light-emitting element corresponding to an imaging device that is identified to have imaging disturbance is turned on.

Details of an identifying display signal is described in the above description of the display device 14, and thus, description thereof is omitted here.

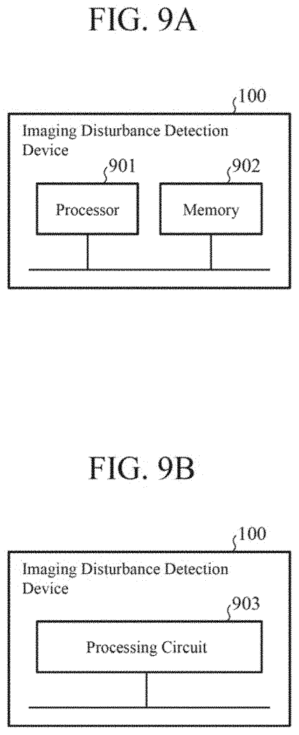

FIGS. 9A and 9B are diagrams showing examples of a hardware configuration of the imaging disturbance detection device 100 in the imaging disturbance detection system 1 according to the first embodiment.

A hardware configuration of the main parts of the imaging disturbance detection device 100 in the imaging disturbance detection system 1 according to the first embodiment will be described with reference to the diagrams.

As shown in FIG. 9A, the imaging disturbance detection device 100 is composed of a computer, and the computer includes a processor 901 and a memory 902. The memory 902 stores a program for causing the computer to function as the estimation information obtaining unit 110, the image obtaining unit 120, the image luminance obtaining unit 130, the reference luminance obtaining unit 140, the disturbance estimating unit 150, the disturbance identifying unit 160, and the output control unit 170. By the processor 901 reading and executing the program stored in the memory 902, functions of the estimation information obtaining unit 110, the image obtaining unit 120, the image luminance obtaining unit 130, the reference luminance obtaining unit 140, the disturbance estimating unit 150, the disturbance identifying unit 160, and the output control unit 170 are implemented.

In addition, as shown in FIG. 9B, the imaging disturbance detection device 100 may be composed of a processing circuit 903. In this case, the functions of the estimation information obtaining unit 110, the image obtaining unit 120, the image luminance obtaining unit 130, the reference luminance obtaining unit 140, the disturbance estimating unit 150, the disturbance identifying unit 160, and the output control unit 170 may be implemented by the processing circuit 903.

In addition, the imaging disturbance detection device 100 may be composed of the processor 901, the memory 902, and the processing circuit 903 (not shown). In this case, some of the functions of the estimation information obtaining unit 110, the image obtaining unit 120, the image luminance obtaining unit 130, the reference luminance obtaining unit 140, the disturbance estimating unit 150, the disturbance identifying unit 160, and the output control unit 170 may be implemented by the processor 901 and the memory 902 and the other functions may be implemented by the processing circuit 903.

The processor 901 uses, for example, a central processing unit (CPU), a graphics processing unit (GPU), a microprocessor, a microcontroller, or a digital signal processor (DSP).

The memory 902 uses, for example, a semiconductor memory or a magnetic disk. More specifically, the memory 902 uses a random access memory (RAM), a read only memory (ROM), a flash memory, an erasable programmable read only memory (EPROM), an electrically erasable programmable read-only memory (EEPROM), a solid state drive (SSD), a hard disk drive (HDD), or the like.

The processing circuit 903 uses, for example, an application specific integrated circuit (ASIC), a programmable logic device (PLD), a field-programmable gate array (FPGA), a system-on-a-chip (SoC), or a system large-scale integration (LSI).

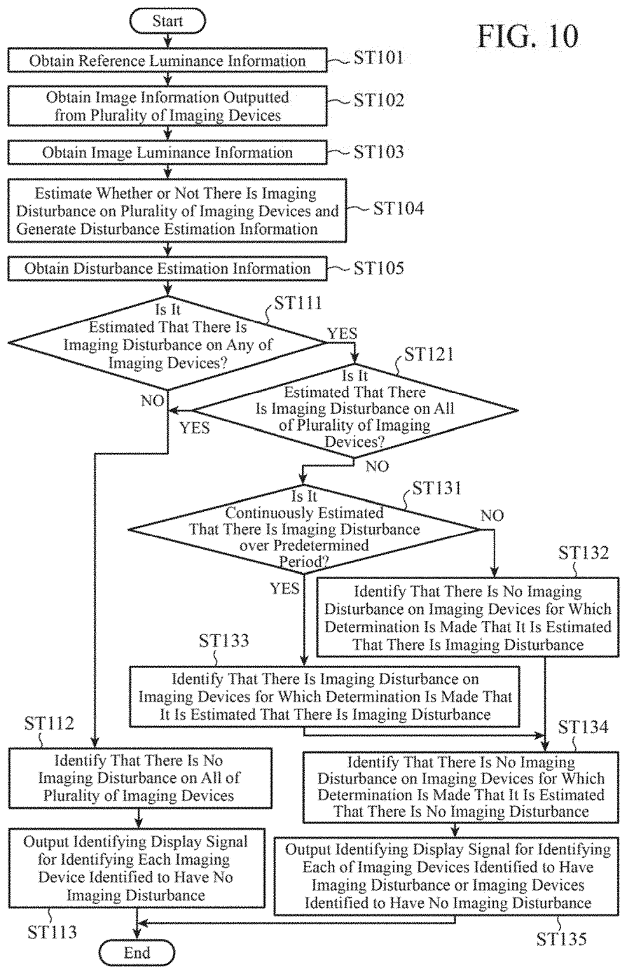

Operations of the imaging disturbance detection device 100 in the imaging disturbance detection system 1 according to the first embodiment will be described with reference to FIG. 10.

FIG. 10 is a flowchart that describes an example of processes performed by the imaging disturbance detection device 100 in the imaging disturbance detection system 1 according to the first embodiment.

The imaging disturbance detection device 100 repeatedly performs the processes of the flowchart, for example, at predetermined intervals, e.g., intervals of 15 minutes, as in the example shown in FIG. 8.

First, at step ST101, the reference luminance obtaining unit 140 obtains pieces of reference luminance information indicating predetermined reference luminance set for each of the plurality of imaging devices 11-1, 11-2, . . . , 11-N.

Then, at step ST102, the image obtaining unit 120 obtains, through the communication network 12, pieces of image information outputted from the plurality of imaging devices 11-1, 11-2, . . . , 11-N.

Then, at step ST103, the image luminance obtaining unit 130 obtains pieces of image luminance information indicating luminance of each of images taken by the imaging devices 11-1, 11-2, . . . , 11-N.

Then, at step ST104, the disturbance estimating unit 150 estimates whether or not there is imaging disturbance on the plurality of imaging devices 11-1, 11-2, . . . , 11-N by comparing the luminance of each of the images indicated by the pieces of image luminance information obtained by the image luminance obtaining unit 130 with the predetermined reference luminance set for each of the plurality of imaging devices 11-1, 11-2, . . . , 11-N and indicated by the pieces of reference luminance information obtained by the reference luminance obtaining unit 140, thereby generating pieces of disturbance estimation information.

Then, at step ST105, the estimation information obtaining unit 110 obtains the pieces of disturbance estimation information generated by the disturbance estimating unit 150.

Then, at step ST111, the disturbance identifying unit 160 determines whether or not it is estimated that there is imaging disturbance on any of the plurality of imaging devices 11-1, 11-2, . . . , 11-N, on the basis of the pieces of disturbance estimation information of the respective plurality of imaging devices 11-1, 11-2, . . . , 11-N which are obtained by the estimation information obtaining unit 110.

If the disturbance identifying unit 160 determines at step ST111 that it is estimated that there is no imaging disturbance on all imaging devices 11-1, 11-2, . . . , 11-N among the plurality of imaging devices 11-1, 11-2, . . . , 11-N, then at step ST112, the disturbance identifying unit 160 identifies that there is no imaging disturbance on all of the plurality of imaging devices 11-1, 11-2, . . . , 11-N.

After step ST112, at step ST113, the output control unit 170 outputs an identifying display signal for identifying each of the imaging devices 11-1, 11-2, . . . , 11-N that are identified by the disturbance identifying unit 160 to have no imaging disturbance.

After step ST113, the imaging disturbance detection device 100 ends the processes of the flowchart and repeatedly performs the processes of the flowchart at predetermined intervals.

If the disturbance identifying unit 160 determines at step ST111 that it is estimated that there is imaging disturbance on any of the plurality of imaging devices 11-1, 11-2, . . . , 11-N, then at step ST121, the disturbance identifying unit 160 determines whether or not it is estimated that there is imaging disturbance on all of the plurality of imaging devices 11-1, 11-2, . . . , 11-N.

If the disturbance identifying unit 160 determines at step ST121 that it is estimated that there is imaging disturbance on all of the plurality of imaging devices 11-1, 11-2, . . . , 11-N, then the imaging disturbance detection device 100 performs a process at step ST112.

If the disturbance identifying unit 160 determines at step ST121 that it is estimated that any of the plurality of imaging devices 11-1, 11-2, . . . , 11-N has no imaging disturbance, then at step ST131, the disturbance identifying unit 160 repeatedly determines, for all imaging devices among the plurality of imaging devices 11-1, 11-2, . . . , 11-N for which the disturbance identifying unit 160 determines at step ST111 that it is estimated that there is imaging disturbance, whether or not it is continuously estimated that there is imaging disturbance over a predetermined period, and the disturbance identifying unit 160 performs one of the following processes at step ST132 and ST133.

If the disturbance identifying unit 160 determines at step ST131 that it is not continuously estimated that there is imaging disturbance over the predetermined period on the imaging devices among the plurality of imaging devices 11-1, 11-2, . . . , 11-N for which the disturbance identifying unit 160 determines at step ST111 that it is estimated that there is imaging disturbance, then at step ST132, the disturbance identifying unit 160 identifies that there is no imaging disturbance on the imaging devices among the plurality of imaging devices 11-1, 11-2, . . . , 11-N for which the disturbance identifying unit 160 determines at step ST111 that it is estimated that there is imaging disturbance.

If the disturbance identifying unit 160 determines at step ST131 that it is continuously estimated that there is imaging disturbance over the predetermined period on the imaging devices among the plurality of imaging devices 11-1, 11-2, . . . , 11-N for which the disturbance identifying unit 160 determines at step ST111 that it is estimated that there is imaging disturbance, then at step ST133, the disturbance identifying unit 160 identifies that there is imaging disturbance on the imaging devices among the plurality of imaging devices 11-1, 11-2, . . . , 11-N for which the disturbance identifying unit 160 determines at step ST111 that it is estimated that there is imaging disturbance.

After step ST132 or ST133, at step ST134, the disturbance identifying unit 160 identifies that there is no imaging disturbance on imaging devices among the plurality of imaging devices 11-1, 11-2, . . . , 11-N for which the disturbance identifying unit 160 determines at step ST111 that it is estimated that there is no imaging disturbance.

After step ST134, at step ST135, the output control unit 170 outputs an identifying display signal for identifying each of imaging devices that are identified by the disturbance identifying unit 160 to have imaging disturbance or imaging devices that are identified by the disturbance identifying unit 160 to have no imaging disturbance.

After step ST135, the imaging disturbance detection device 100 ends the processes of the flowchart, and repeatedly performs the processes of the flowchart at predetermined intervals.

Note that it may be configured that the process at step ST101 is performed only once in the first series of processes when the imaging disturbance detection device 100 repeatedly performs the processes of the flowchart at predetermined intervals.

Note also that when the estimation information obtaining unit 110 can obtain, at step ST105, disturbance estimation information from each of the plurality of imaging devices 11-1, 11-2, . . . , 11-N or an external device such as the image recording device 13, the processes at step ST101 to ST104 are not essential processes.

As described above, the imaging disturbance detection device 100 includes the estimation information obtaining unit 110 that obtains pieces of disturbance estimation information indicating whether or not there is imaging disturbance on each of the plurality of imaging devices 11-1, 11-2, . . . , 11-N installed on the inside of the railroad car 10, which is estimated by comparing luminance of each of images taken by the plurality of imaging devices 11-1, 11-2, . . . , 11-N with predetermined reference luminance set for each of the plurality of imaging devices 11-1, 11-2, . . . , 11-N; the disturbance identifying unit 160 that identifies, when it is estimated, on the basis of the pieces of disturbance estimation information of the respective plurality of imaging devices 11-1, 11-2, . . . , 11-N obtained by the estimation information obtaining unit 110, that there is imaging disturbance on a first imaging device among the plurality of imaging devices 11-1, 11-2, . . . , 11-N, whether or not there is imaging disturbance on the first imaging device on the basis of which one, the presence or absence of imaging disturbance, is estimated for a second imaging device different from the first imaging device among the plurality of imaging devices 11-1, 11-2, . . . , 11-N, and the length of a period during which it is continuously estimated that there is imaging disturbance on the first imaging device; and the output control unit 170 that outputs an identifying display signal for identifying the first imaging device that is identified by the disturbance identifying unit 160 to have imaging disturbance.

By such a configuration, the imaging disturbance detection device 100 can accurately determine whether or not an imaging device installed in a railroad car is in an imaging abnormal state. Particularly, by such a configuration, when it is estimated that there is imaging disturbance on a first imaging device among the plurality of imaging devices 11-1, 11-2, . . . , 11-N, the imaging disturbance detection device 100 can determine whether there is imaging disturbance on the first imaging device or whether the illumination of the inside of the entire railroad car is insufficient.

In addition, by such a configuration, since the imaging disturbance detection device 100 identifies whether or not there is imaging disturbance on the basis of luminance of an image, a load on hardware such as a CPU is small compared to a case of identifying whether or not there is imaging disturbance on the basis of an image determination technique such as pattern matching in which features of images are compared with each other, and thus, processes can be performed at high speed.

### Second Embodiment

An imaging disturbance detection device 100a according to a second embodiment differs in that the imaging disturbance detection device 100a includes a time mode switching unit 180 and a location mode switching unit 181 which are not included in the imaging disturbance detection device 100 according to the first embodiment.

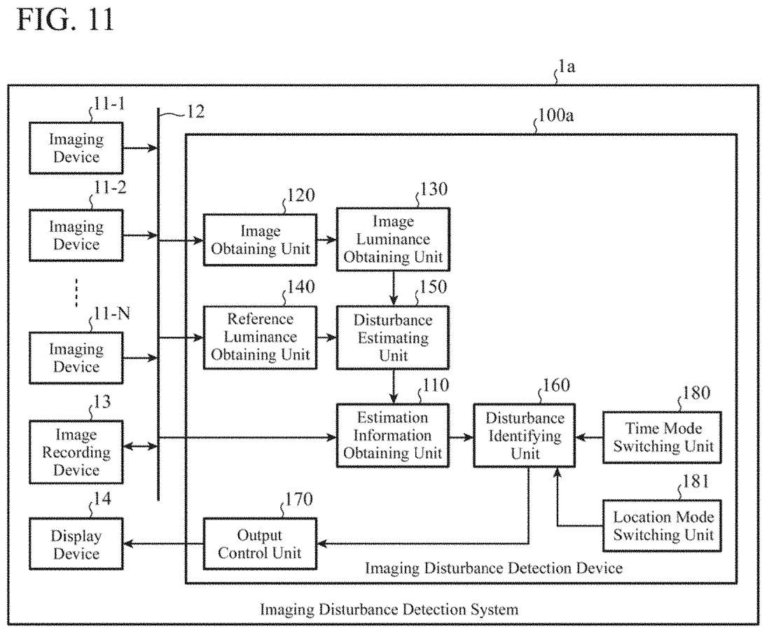

FIG. 11 is a block diagram showing an example of a configuration of main parts of the imaging disturbance detection device 100a in an imaging disturbance detection system 1a according to the second embodiment.

Using FIG. 11, the configuration of the imaging disturbance detection device 100a according to the second embodiment will be described. Note that in FIG. 11 the same components as those in the diagram shown in FIG. 6 are given the same reference signs and description thereof is omitted.

The imaging disturbance detection device 100a in the imaging disturbance detection system 1a according to the second embodiment includes the estimation information obtaining unit 110, the image obtaining unit 120, the image luminance obtaining unit 130, the reference luminance obtaining unit 140, the disturbance estimating unit 150, the disturbance identifying unit 160, the output control unit 170, the time mode switching unit 180, and the location mode switching unit 181.

The time mode switching unit 180 switches, on the basis of time information indicating a current time, between two operating modes: a disturbance detection mode in which whether or not there is imaging disturbance is detected for each of the plurality of imaging devices 11-1, 11-2, . . . , 11-N, and a detection pause mode in which whether or not there is imaging disturbance is not detected for each of the plurality of imaging devices 11-1, 11-2, . . . , 11-N.

Specifically, for example, the time mode switching unit 180 switches between the operating modes so that operations are performed in the detection pause mode during a time period during which there is influence of sunlight when each of the plurality of imaging devices 11-1, 11-2, . . . , 11-N performs imaging, and switches between the operating modes so that operations are performed in the disturbance detection mode during a time period during which there is no influence of sunlight when each of the plurality of imaging devices 11-1, 11-2, . . . , 11-N performs imaging, on the basis of time period information in which time periods during which there is influence of sunlight when each of the plurality of imaging devices 11-1, 11-2, . . . , 11-N performs imaging are determined in advance, and time information.

More specifically, for example, the time mode switching unit 180 switches between the operating modes so that operations are performed in the detection pause mode during daytime hours during which there is influence of sunlight when each of the plurality of imaging devices 11-1, 11-2, . . . , 11-N performs imaging, and switches between the operating modes so that operations are performed in the disturbance detection mode during nighttime hours during which there is no influence of sunlight when each of the plurality of imaging devices 11-1, 11-2, . . . , 11-N performs imaging.

The time information is obtained using, for example, a clock function (not shown) provided to the imaging disturbance detection device 100a. The clock function is the same as, for example, a clock function provided to an electronic device such as a publicly known general-purpose computing machine, and is a publicly known technique, and thus, a detailed description thereof is omitted.

The time period information is, for example, held in advance in the time mode switching unit 180. In addition, for example, the time period information may be obtained by the time mode switching unit 180 from a storage device (not shown) provided inside or outside a casing of the imaging disturbance detection device 100a or an external device such as the image recording device 13 through the communication network 12.

By the imaging disturbance detection device 100a thus including the time mode switching unit 180, the imaging disturbance detection device 100a detects whether or not there is imaging disturbance on each of the plurality of imaging devices 11-1, 11-2, . . . , 11-N during a time period during which there is no influence of sunlight when each of the plurality of imaging devices 11-1, 11-2, . . . , 11-N performs imaging, and thus, erroneous detection can be suppressed.

The location mode switching unit 181 switches, on the basis of location information indicating a location through which the railroad car 10 travels, between two operating modes: a disturbance detection mode in which whether or not there is imaging disturbance is detected for each of the plurality of imaging devices 11-1, 11-2, . . . , 11-N, and a detection pause mode in which whether or not there is imaging disturbance is not detected for each of the plurality of imaging devices.

Specifically, for example, the location mode switching unit 181 switches between the operating modes so that operations are performed in the detection pause mode when the railroad car 10 travels through a location where there is influence of sunlight when each of the plurality of imaging devices 11-1, 11-2, . . . , 11-N performs imaging, and switches between the operating modes so that operations are performed in the disturbance detection mode when the railroad car 10 travels through a location where there is no influence of sunlight when each of the plurality of imaging devices 11-1, 11-2, . . . , 11-N performs imaging, on the basis of location influence information in which information indicating each of a plurality of locations on a route that the railroad car 10 travels is associated in advance with information indicating whether or not there is influence of sunlight when each of the plurality of imaging devices 11-1, 11-2, . . . , 11-N performs imaging at each location, and location information.

More specifically, for example, the location mode switching unit 181 switches between the operating modes so that operations are performed in the detection pause mode when the railroad car 10 travels on the ground where there is influence of sunlight when each of the plurality of imaging devices 11-1, 11-2, . . . , 11-N performs imaging, and switches between the operating modes so that operations are performed in the disturbance detection mode when the railroad car 10 travels underground where there is no influence of sunlight when each of the plurality of imaging devices 11-1, 11-2, . . . , 11-N performs imaging.

The location information is obtained using, for example, a travel location detecting function (not shown) provided to the railroad car 10, a train to which the railroad car 10 is connected, etc. The travel location detecting function detects a location of the railroad car 10 using, for example, a global navigation satellite system (GNSS) such as a global positioning system (GPS). A location detection method using GNSS is publicly known and thus a detailed description thereof is omitted.

The location influence information is, for example, held in advance in the location mode switching unit 181. In addition, for example, the location influence information may be obtained by the location mode switching unit 181 from a storage device (not shown) provided inside or outside the casing of the imaging disturbance detection device 100a or an external device such as the image recording device 13 through the communication network 12.

By the imaging disturbance detection device 100a thus including the location mode switching unit 181, the imaging disturbance detection device 100a detects whether or not there is imaging disturbance on each of the plurality of imaging devices 11-1, 11-2, . . . , 11-N at a location where there is no influence of sunlight when each of the plurality of imaging devices 11-1, 11-2, . . . , 11-N performs imaging, and thus, erroneous detection can be suppressed.

Note that the imaging disturbance detection device 100a may include the time mode switching unit 180 or the location mode switching unit 181 or may include the time mode switching unit 180 and the location mode switching unit 181.

For example, when the imaging disturbance detection device 100a includes the time mode switching unit 180 and the location mode switching unit 181, during a time period during which the operating mode is set to the disturbance detection mode by the time mode switching unit 180, the imaging disturbance detection device 100a may operate in the disturbance detection mode, and during a time period during which the operating mode is set to the detection pause mode by the time mode switching unit 180, the imaging disturbance detection device 100a may operate in the disturbance detection mode only at a location where the operating mode is set to the disturbance detection mode by the location mode switching unit 181.

A hardware configuration of main parts of the imaging disturbance detection device 100a is the same as that described by referring to FIGS. 9A and 9B in the first embodiment, and thus, depiction and description thereof are omitted. Namely, each function of the estimation information obtaining unit 110, the image obtaining unit 120, the image luminance obtaining unit 130, the reference luminance obtaining unit 140, the disturbance estimating unit 150, the disturbance identifying unit 160, the output control unit 170, the time mode switching unit 180, and the location mode switching unit 181 may be implemented by the processor 901 and the memory 902 or may be implemented by the processing circuit 903.

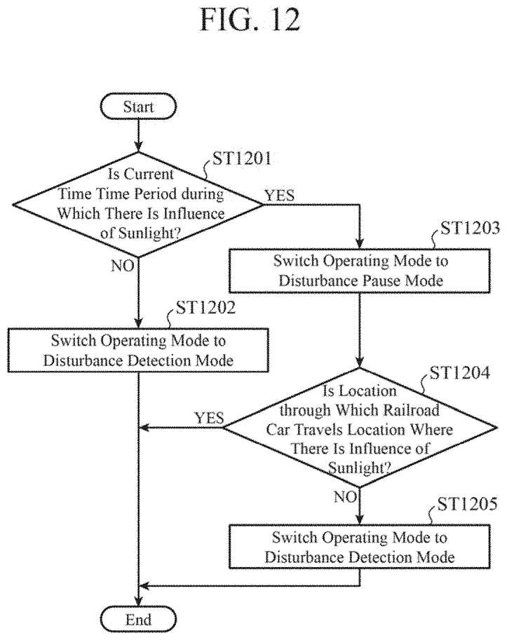

FIG. 12 is a flowchart that describes an example of processes performed by the imaging disturbance detection device 100a in the imaging disturbance detection system 1a according to the second embodiment.

The processes performed by the imaging disturbance detection device 100a in the imaging disturbance detection system 1a according to the second embodiment will be described with reference to the diagram.

The imaging disturbance detection device 100a repeatedly performs the processes of the flowchart as preceding processes to the processes of the flowchart shown in FIG. 10, and the imaging disturbance detection system 1a performs the processes of the flowchart shown in FIG. 10 only when the operating mode is the disturbance detection mode.

First, at step ST1201, the time mode switching unit 180 determines whether or not a current time is a time period during which there is influence of sunlight.

If the time mode switching unit 180 determines at step ST1201 that the current time is not a time period during which there is influence of sunlight, then at step ST1202, the time mode switching unit 180 switches the operating mode to the disturbance detection mode.

After step ST1202, the imaging disturbance detection device 100a ends the processes of the flowchart and repeatedly performs the processes of the flowchart.

If the time mode switching unit 180 determines at step ST1201 that the current time is a time period during which there is influence of sunlight, then at step ST1203, the time mode switching unit 180 switches the operating mode to the detection pause mode.

After step ST1203, at step ST1204, the location mode switching unit 181 determines whether or not a location through which the railroad car 10 travels is a location where there is influence of sunlight.

If the location mode switching unit 181 determines at step ST1204 that the location through which the railroad car 10 travels is a location where there is influence of sunlight, then the imaging disturbance detection device 100a ends the processes of the flowchart and repeatedly performs the processes of the flowchart.

If the location mode switching unit 181 determines at step ST1204 that the location through which the railroad car 10 travels is not a location where there is influence of sunlight, then at step ST1205, the location mode switching unit 181 switches the operating mode to the disturbance detection mode.

After step ST1205, the imaging disturbance detection device 100a ends the processes of the flowchart and repeatedly performs the processes of the flowchart.

### Third Embodiment

An imaging disturbance detection device 100b according to a third embodiment differs in that the imaging disturbance detection device 100b includes an information providing unit 190 and an another device's estimation information obtaining unit 191 which are not included in the imaging disturbance detection device 100 according to the first embodiment, and the disturbance identifying unit 160 in the imaging disturbance detection device 100 according to the first embodiment is changed to a disturbance identifying unit 160b.

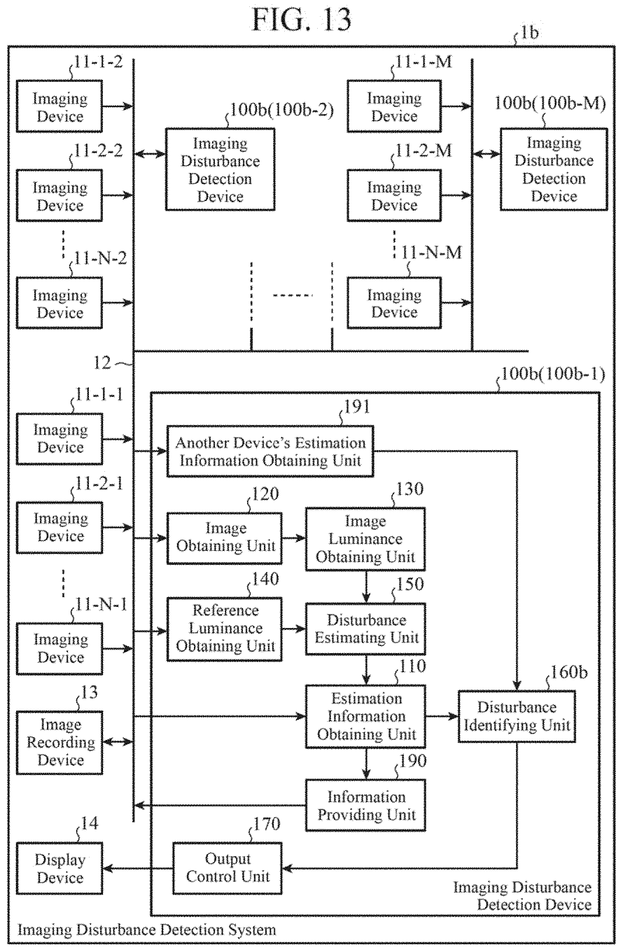

FIG. 13 is a block diagram showing an example of a configuration of main parts of the imaging disturbance detection device 100b in an imaging disturbance detection system 1b according to the third embodiment.

Using FIG. 13, the configuration of the imaging disturbance detection device 100b according to the third embodiment will be described. Note that in FIG. 13 the same components as those in the diagram shown in FIG. 6 are given the same reference signs and description thereof is omitted.

The imaging disturbance detection device 100b in the imaging disturbance detection system 1b according to the third embodiment includes the estimation information obtaining unit 110, the image obtaining unit 120, the image luminance obtaining unit 130, the reference luminance obtaining unit 140, the disturbance estimating unit 150, the disturbance identifying unit 160b, the output control unit 170, the information providing unit 190, and the another device's estimation information obtaining unit 191.

The imaging disturbance detection system 1b includes a plurality of railroad cars 10-1, 10-2, . . . , 10-M (M is a natural number greater than or equal to 2) connected to each other which are not shown.

In addition, the imaging disturbance detection system 1b includes a plurality of imaging disturbance detection devices 100b-1, 100b-2, 100b-M corresponding to the plurality of railroad cars 10-1, 10-2, . . . , 10-M, respectively.

In addition, in the imaging disturbance detection system 1b, a plurality of imaging devices 11-1, 11-2, . . . , 11-N are installed on each of the plurality of railroad cars 10-1, 10-2, . . . , 10-M. In the following description, a plurality of imaging devices 11-1, 11-2, . . . , 11-N installed on a railroad car 10-m (m is a natural number between 1 and M, inclusive) are represented as imaging devices 11-1-m, 11-2-m, . . . , 11-N-m, respectively.

Note that the plurality of railroad cars 10-1, 10-2, . . . , 10-M do not need to have the same number of a plurality of imaging devices 11-1-m, 11-2-m, . . . , 11-N-m installed thereon.

In FIG. 13, description is made assuming that the plurality of imaging devices 11-1-m, 11-2-m, . . . , 11-N-m installed on the railroad car 10-m are associated with the imaging disturbance detection device 100b-m.

The information providing unit 190 provides pieces of disturbance estimation information obtained by the estimation information obtaining unit 110, as pieces of another device's disturbance estimation information, to other imaging disturbance detection devices 100b.

Specifically, for example, in the imaging disturbance detection system 1b shown in FIG. 13, the information providing unit 190 in the imaging disturbance detection device 100b-1 provides pieces of disturbance estimation information obtained by the estimation information obtaining unit 110 in the imaging disturbance detection device 100b-1, as pieces of another device's disturbance estimation information, to other imaging disturbance detection devices 100b-2, 100b-M.

The another device's estimation information obtaining unit 191 obtains pieces of another device's disturbance estimation information provided from other imaging disturbance detection devices 100b.

Specifically, for example, in the imaging disturbance detection system 1b shown in FIG. 13, the another device's estimation information obtaining unit 191 in the imaging disturbance detection device 100b-1 obtains pieces of another device's disturbance estimation information provided from the information providing units 190 in other imaging disturbance detection devices 100b-2, 100b-M.

When it is estimated, on the basis of pieces of disturbance estimation information obtained by the estimation information obtaining unit 110 in the imaging disturbance detection device 100b-1, that there is imaging disturbance on all of a plurality of imaging devices 11-1-1, 11-2-1, . . . , 11-N-1 among the plurality of imaging devices 11-1-1, 11-2-1, . . . , 11-N-1 upon identifying whether or not there is imaging disturbance on a first imaging device on the basis of the pieces of disturbance estimation information, the disturbance identifying unit 160b in the imaging disturbance detection device 100b-1 identifies, for all of the imaging devices 11-1-1, 11-2-1, . . . , 11-N-1, whether or not there is imaging disturbance on the basis of pieces of another device's disturbance estimation information obtained by the another device's estimation information obtaining unit 191 in the imaging disturbance detection device 100b-1.

Specifically, for example, in the imaging disturbance detection system 1b shown in FIG. 13, when it is estimated, on the basis of pieces of disturbance estimation information obtained by the estimation information obtaining unit 110 in the imaging disturbance detection device 100b-1, that there is imaging disturbance on all of the plurality of imaging devices 11-1-1, 11-2-1, . . . , 11-N-1 upon identifying, by the disturbance identifying unit 160b in the imaging disturbance detection device 100b-1, whether or not there is imaging disturbance on a first imaging device on the basis of the pieces of disturbance estimation information, the another device's estimation information obtaining unit 191 in the imaging disturbance detection device 100b-1 obtains pieces of another device's disturbance estimation information provided from the information providing units 190 in other imaging disturbance detection devices 100b-2, . . . , 100b-M. The pieces of another device's disturbance estimation information provided from the information providing units 190 in the imaging disturbance detection devices 100b-2, 100b-M are pieces of disturbance estimation information indicating whether or not there is imaging disturbance on each of the imaging devices 11-1-2, 11-2-2, . . . , 11-N-2, . . . , 11-1-M, 11-2-M, . . . , 11-N-M which is estimated by comparing luminance of each of images taken by a plurality of imaging devices 11-1-2, 11-2-2, . . . , 11-N-2, . . . , 11-1-M, 11-2-M, . . . , 11-N-M installed on the inside of the railroad cars 10-2, . . . , 10-M with predetermined reference luminance set for each of the imaging devices 11-1-2, 11-2-2, . . . , 11-N-2, . . . , 11-1-M, 11-2-M, . . . , 11-N-M.

The disturbance identifying unit 160b in the imaging disturbance detection device 100b-1 checks whether or not there is imaging disturbance on each of the plurality of imaging devices 11-1-2, 11-2-2, . . . , 11-N-2, . . . , 11-1-M, 11-2-M, . . . , 11-N-M installed on the railroad cars 10-2, . . . , 10-M, on the basis of the obtained pieces of another device's disturbance estimation information.

For example, when it is estimated that there is imaging disturbance on all of the plurality of imaging devices 11-1-2, 11-2-2, . . . , 11-N-2, . . . , 11-1-M, 11-2-M, . . . , 11-N-M installed on the railroad cars 10-2, . . . , 10-M, the disturbance identifying unit 160b in the imaging disturbance detection device 100b-1 identifies that there is no imaging disturbance on all of the plurality of imaging devices 11-1-1, 11-2-1, . . . , 11-N-1 installed on the railroad car 10-1.

In addition, for example, when it is estimated that any of the plurality of imaging devices 11-1-2, 11-2-2, . . . , 11-N-2, . . . , 11-1-M, 11-2-M, . . . , 11-N-M installed on the railroad cars 10-2, . . . , 10-M has no imaging disturbance, the disturbance identifying unit 160b in the imaging disturbance detection device 100b-1 identifies that there is imaging disturbance on all of the plurality of imaging devices 11-1-1, 11-2-1, . . . , 11-N-1 installed on the railroad car 10-1.

This identification is made because when it is estimated that there is imaging disturbance on all of the plurality of imaging devices 11-1-1, 11-2-1, . . . , 11-N-1, . . . , 11-1-M, 11-2-M, . . . , 11-N-M installed on the plurality of railroad cars 10-1, 10-2, . . . , 10-M connected to each other, it is assumed that the illumination in all railroad cars 10-1, 10-2, . . . , 10-M is insufficient, e.g., when the plurality of railroad cars 10-1, 10-2, . . . , 10-M connected to each other are housed in a train depot.

In addition, this identification is made because when it is estimated that any of the plurality of imaging devices 11-1-1, 11-2-1, . . . , 11-N-1, . . . , 11-1-M, 11-2-M, . . . , 11-N-M installed on the plurality of railroad cars 10-1, 10-2, . . . , 10-M connected to each other has no imaging disturbance, it is assumed that there is a possibility that optical systems such as lenses of all of the plurality of imaging devices 11-1-1, 11-2-1, . . . , 11-N-1 installed on the railroad car 10-1 may be covered by light-shielding cloths, etc.

As such, by the imaging disturbance detection device 100b including the information providing unit 190 and the another device's estimation information obtaining unit 191 and configuring the disturbance identifying unit 160 in the imaging disturbance detection device 100 according to the first embodiment as the disturbance identifying unit 160b, even when it is estimated that there is imaging disturbance on all of a plurality of imaging devices 11-1, 11-2, . . . , 11-N installed on a given railroad car 10, erroneous detection can be suppressed.

A hardware configuration of main parts of the imaging disturbance detection device 100b is the same as that described by referring to FIGS. 9A and 9B in the first embodiment, and thus, depiction and description thereof are omitted. Namely, each function of the estimation information obtaining unit 110, the image obtaining unit 120, the image luminance obtaining unit 130, the reference luminance obtaining unit 140, the disturbance estimating unit 150, the disturbance identifying unit 160b, the output control unit 170, the information providing unit 190, and the another device's estimation information obtaining unit 191 may be implemented by the processor 901 and the memory 902 or may be implemented by the processing circuit 903.

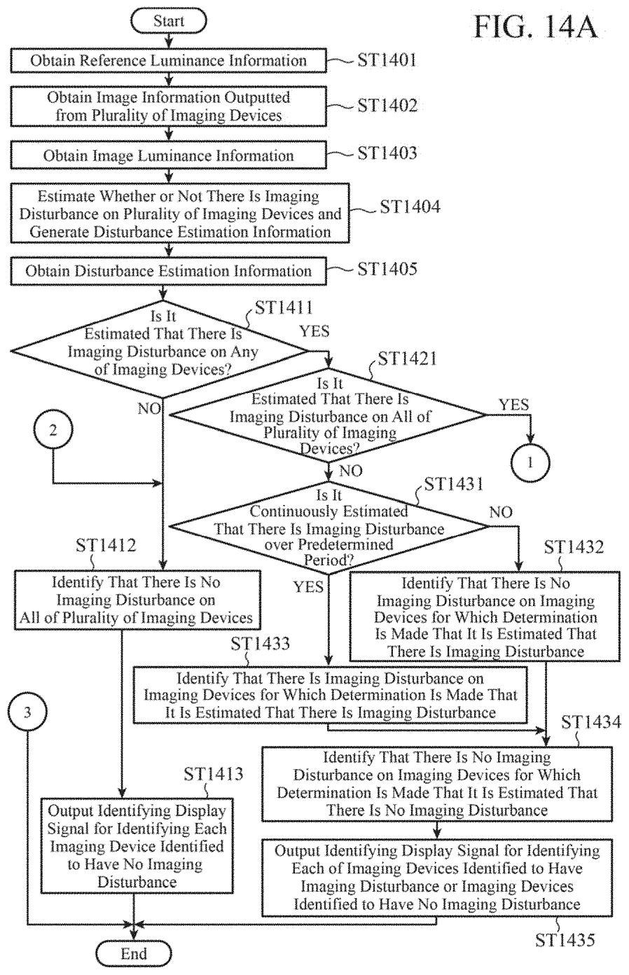

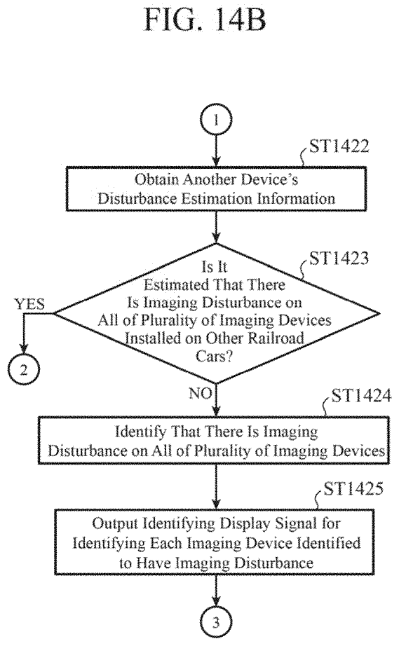

FIGS. 14A and 14B are flowcharts that describe an example of processes performed by the imaging disturbance detection device 100b-1 in the imaging disturbance detection system 1b according to the third embodiment.

The processes performed by the imaging disturbance detection device 100b-1 in the imaging disturbance detection system 1b according to the third embodiment will be described with reference to the diagrams.

The imaging disturbance detection device 100b-1 repeatedly performs processes of the flowcharts at predetermined intervals. Note that the processes of the flowcharts shown in FIGS. 14A and 14B are given the same reference signs as the processes of the flowchart shown in FIG. 10 and a detailed description thereof is omitted.

First, at step ST1401, the reference luminance obtaining unit 140 obtains pieces of reference luminance information indicating predetermined reference luminance set for each of the plurality of imaging devices 11-1-1, 11-2-1, . . . , 11-N-1.

Then, at step ST1402, the image obtaining unit 120 obtains, through the communication network 12, pieces of image information outputted from the respective plurality of imaging devices 11-1-1, 11-2-1, . . . , 11-N-1.

Then, at step ST1403, the image luminance obtaining unit 130 obtains pieces of image luminance information indicating luminance of each of images taken by the respective plurality of imaging devices 11-1-1, 11-2-1, . . . , 11-N-1.

Then, at step ST1404, the disturbance estimating unit 150 estimates whether or not there is imaging disturbance on each of the plurality of imaging devices 11-1-1, 11-2-1, . . . , 11-N-1 by comparing the luminance of each of the images indicated by the pieces of image luminance information obtained by the image luminance obtaining unit 130 with the predetermined reference luminance set for each of the plurality of imaging devices 11-1-1, 11-2-1, . . . , 11-N-1 and indicated by the pieces of reference luminance information obtained by the reference luminance obtaining unit 140, thereby generating pieces of disturbance estimation information.

Then, at step ST1405, the estimation information obtaining unit 110 obtains the pieces of disturbance estimation information generated by the disturbance estimating unit 150.

Then, at step ST1411, the disturbance identifying unit 160b determines whether or not it is estimated that there is imaging disturbance on any of the plurality of imaging devices 11-1-1, 11-2-1, . . . , 11-N-1, on the basis of the pieces of disturbance estimation information of the respective plurality of imaging devices 11-1-1, 11-2-1, . . . , 11-N-1 which are obtained by the estimation information obtaining unit 110.

If the disturbance identifying unit 160b determines at step ST1411 that it is estimated that there is no imaging disturbance on all imaging devices 11-1-1, 11-2-1, . . . , 11-N-1 among the plurality of imaging devices 11-1-1, 11-2-1, . . . , 11-N-1, then at step ST1412, the disturbance identifying unit 160b identifies that there is no imaging disturbance on all of the plurality of imaging devices 11-1-1, 11-2-1, . . . , 11-N-1.

After step ST1412, at step ST1413, the output control unit 170 outputs an identifying display signal for identifying each of the imaging devices 11-1-1, 11-2-1, . . . , 11-N-1 that are identified by the disturbance identifying unit 160b to have no imaging disturbance.

After step ST1413, the imaging disturbance detection device 100b-1 ends the processes of the flowcharts and repeatedly performs the processes of the flowcharts at predetermined intervals.

If the disturbance identifying unit 160b determines at step ST1411 that it is estimated that there is imaging disturbance on any of the plurality of imaging devices 11-1-1, 11-2-1, . . . , 11-N-1, then at step ST1421, the disturbance identifying unit 160b determines whether or not it is estimated that there is imaging disturbance on all of the plurality of imaging devices 11-1-1, 11-2-1, . . . , 11-N-1.

If the disturbance identifying unit 160b determines at step ST1421 that it is estimated that there is imaging disturbance on all of the plurality of imaging devices 11-1-1, 11-2-1, . . . , 11-N-1, then at step ST1422, the another device's estimation information obtaining unit 191 obtains pieces of another device's disturbance estimation information provided from other imaging disturbance detection devices 100b-2, 100b-M.

After step ST1422, at step ST1423, the disturbance identifying unit 160b determines whether or not it is estimated that there is imaging disturbance on all of the plurality of imaging devices 11-1-2, 11-2-2, . . . , 11-N-2, . . . , 11-1-M, 11-2-M, . . . , 11-N-M, on the basis of the pieces of another device's disturbance estimation information.

If the disturbance identifying unit 160b determines at step ST1423 that it is estimated that there is imaging disturbance on all of the plurality of imaging devices 11-1-2, 11-2-2, . . . , 11-N-2, . . . , 11-1-M, 11-2-M, . . . , 11-N-M, on the basis of the pieces of another device's disturbance estimation information, then the imaging disturbance detection device 100b-1 performs a process at step ST1412.

If the disturbance identifying unit 160b determines at step ST1423 that it is estimated that any of the plurality of imaging devices 11-1-2, 11-2-2, . . . , 11-N-2, . . . , 11-1-M, 11-2-M, . . . , 11-N-M has no imaging disturbance, on the basis of the pieces of another device's disturbance estimation information, then at step ST1424, the disturbance identifying unit 160b identifies that there is imaging disturbance on all of the plurality of imaging devices 11-1-1, 11-2-1, . . . , 11-N-1.

After step ST1424, at step ST1425, the output control unit 170 outputs an identifying display signal for identifying each of the imaging devices 11-1-1, 11-2-1, . . . , 11-N-1 that are identified by the disturbance identifying unit 160b to have imaging disturbance.

After step ST1425, the imaging disturbance detection device 100b-1 ends the processes of the flowcharts and repeatedly performs the processes of the flowcharts at predetermined intervals.

If the disturbance identifying unit 160b determines at step ST1421 that it is estimated that any of the plurality of imaging devices 11-1-1, 11-2-1, . . . , 11-N-1 has no imaging disturbance, then at step ST1431, the disturbance identifying unit 160b repeatedly determines, for all imaging devices among the plurality of imaging devices 11-1-1, 11-2-1, . . . , 11-N-1 for which the disturbance identifying unit 160b determines at step ST1411 that it is estimated that there is imaging disturbance, whether or not it is continuously estimated that there is imaging disturbance over a predetermined period, and the disturbance identifying unit 160b performs one of the following processes at step ST1432 and ST1433.

If the disturbance identifying unit 160b determines at step ST1431 that it is not continuously estimated that there is imaging disturbance over the predetermined period on the imaging devices among the plurality of imaging devices 11-1-1, 11-2-1, . . . , 11-N-1 for which the disturbance identifying unit 160b determines at step ST1411 that it is estimated that there is imaging disturbance, then at step ST1432, the disturbance identifying unit 160b identifies that there is no imaging disturbance on the imaging devices among the plurality of imaging devices 11-1-1, 11-2-1, . . . , 11-N-1 for which the disturbance identifying unit 160b determines at step ST1411 that it is estimated that there is imaging disturbance.

If the disturbance identifying unit 160b determines at step ST1431 that it is continuously estimated that there is imaging disturbance over the predetermined period on the imaging devices among the plurality of imaging devices 11-1-1, 11-2-1, . . . , 11-N-1 for which the disturbance identifying unit 160b determines at step ST1411 that it is estimated that there is imaging disturbance, then at step ST1433, the disturbance identifying unit 160b identifies that there is imaging disturbance on the imaging devices among the plurality of imaging devices 11-1-1, 11-2-1, . . . , 11-N-1 for which the disturbance identifying unit 160b determines at step ST1411 that it is estimated that there is imaging disturbance.

After step ST1432 or ST1433, at step ST1434, the disturbance identifying unit 160b identifies that there is no imaging disturbance on imaging devices among the plurality of imaging devices 11-1-1, 11-2-1, . . . , 11-N-1 for which the disturbance identifying unit 160b determines at step ST1411 that it is estimated that there is no imaging disturbance.

After step ST1434, at step ST1435, the output control unit 170 outputs an identifying display signal for identifying each of the imaging devices that are identified by the disturbance identifying unit 160b to have imaging disturbance or the imaging devices that are identified by the disturbance identifying unit 160b to have no imaging disturbance.

After step ST1435, the imaging disturbance detection device 100 ends the processes of the flowcharts and repeatedly performs the processes of the flowcharts at predetermined intervals.

Note that it may be configured that the process at step ST1401 is performed only once in the first series of processes when the imaging disturbance detection device 100b-1 repeatedly performs the processes of the flowcharts at predetermined intervals.

Note also that when the estimation information obtaining unit 110 can obtain, at step ST1405, disturbance estimation information from each of the plurality of imaging devices 11-1-1, 11-2-1, . . . , 11-N-1 or an external device such as the image recording device 13, the processes at step ST1401 to ST1404 are not essential processes.

### Fourth Embodiment

An imaging disturbance detection device 100c according to a fourth embodiment differs from the imaging disturbance detection device 100 according to the first embodiment in that the disturbance identifying unit 160 is changed to a disturbance identifying unit 160c, and the imaging disturbance detection device 100c further includes an imaging parameter estimation information obtaining unit 111, an imaging parameter obtaining unit 131, a reference imaging parameter obtaining unit 141, and an imaging parameter disturbance estimating unit 151.

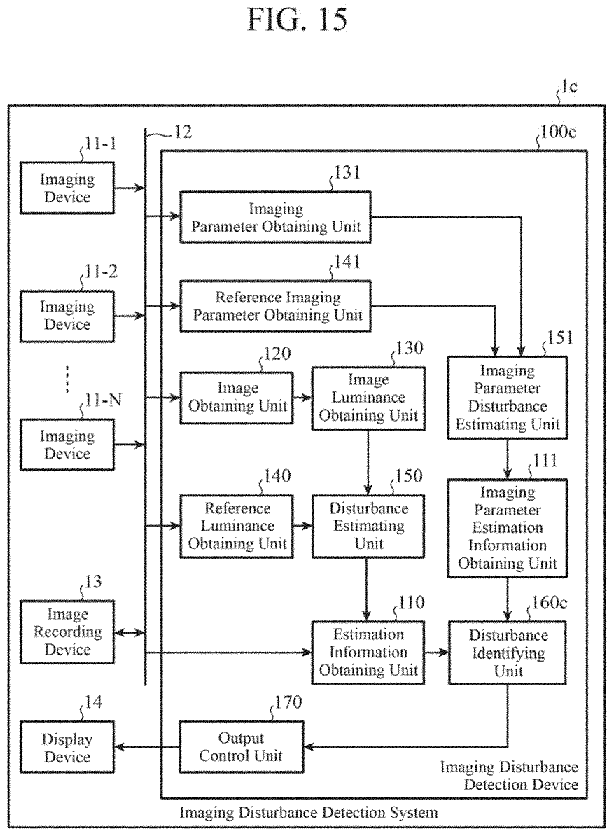

FIG. 15 is a block diagram showing an example of a configuration of main parts of the imaging disturbance detection device 100c in an imaging disturbance detection system 1c according to the fourth embodiment.

Using FIG. 15, the configuration of the imaging disturbance detection device 100c according to the fourth embodiment will be described. Note that in FIG. 15 the same components as those in the diagram shown in FIG. 6 are given the same reference signs and description thereof is omitted.

The imaging disturbance detection device 100c in the imaging disturbance detection system 1c according to the fourth embodiment includes the estimation information obtaining unit 110, the image obtaining unit 120, the image luminance obtaining unit 130, the reference luminance obtaining unit 140, the disturbance estimating unit 150, the imaging parameter estimation information obtaining unit 111, the imaging parameter obtaining unit 131, the reference imaging parameter obtaining unit 141, the imaging parameter disturbance estimating unit 151, the disturbance identifying unit 160c, and the output control unit 170.

The imaging parameter obtaining unit 131 obtains pieces of imaging parameter information indicating imaging parameters used when images are taken by the respective plurality of imaging devices 11-1, 11-2, . . . , 11-N.

Specifically, for example, the imaging parameter obtaining unit 131 obtains pieces of imaging parameter information from the imaging devices 11-1, 11-2, . . . , 11-N through the communication network 12. The imaging parameter obtaining unit 131 may obtain, for example, imaging parameter information recorded in the image recording device 13 through the communication network 12 by reading the imaging parameter information from the image recording device 13.

An imaging parameter indicated by imaging parameter information is international organization for standardization (ISO) sensitivity value, a shutter speed value, an automatic exposure (AE) detection value, an autofocus (AF) detection value, or the like.

The reference imaging parameter obtaining unit 141 obtains pieces of reference imaging parameter information indicating predetermined reference imaging parameters set for the respective plurality of imaging devices 11-1, 11-2, . . . , 11-N.

Specifically, for example, the reference imaging parameter obtaining unit 141 obtains pieces of reference imaging parameter information from the imaging devices 11-1, 11-2, . . . , 11-N through the communication network 12. For example, the reference imaging parameter obtaining unit 141 may obtain the reference imaging parameter information by obtaining the reference imaging parameter information from the image recording device 13 through the communication network 12. In addition, for example, the reference imaging parameter obtaining unit 141 may obtain reference imaging parameter information by reading the reference imaging parameter information from a storage device (not shown) provided inside or outside a casing of the imaging disturbance detection device 100c. In addition, for example, the reference imaging parameter obtaining unit 141 may obtain, as pieces of reference imaging parameter information, pieces of imaging parameter information indicating imaging parameters used when images are taken by the respective plurality of imaging devices 11-1, 11-2, . . . , 11-N, for example, during a time period that is found in advance to have no imaging disturbance.

A reference imaging parameter indicated by reference imaging parameter information is, for example, a value indicating the scope of application of an imaging parameter such as an ISO sensitivity value, a shutter speed value, an f-number, or an autofocus detection value, which is reference used when an image is taken by each of the plurality of imaging devices 11-1, 11-2, . . . , 11-N.

The imaging parameter disturbance estimating unit 151 estimates whether or not there is imaging disturbance on each of the plurality of imaging devices 11-1, 11-2, . . . , 11-N by comparing imaging parameters used when images are taken by the respective plurality of imaging devices 11-1, 11-2, . . . , 11-N which are indicated by the pieces of imaging parameter information obtained by the imaging parameter obtaining unit 131, with predetermined reference imaging parameters set for the respective plurality of imaging devices 11-1, 11-2, . . . , 11-N and indicated by the pieces of reference imaging parameter information obtained by the reference imaging parameter obtaining unit 141.

Specifically, for example, the imaging parameter disturbance estimating unit 151 estimates whether or not there is imaging disturbance on each of the plurality of imaging devices 11-1, 11-2, . . . , 11-N by determining whether or not an imaging parameter used when an image is taken by each of the plurality of imaging devices 11-1, 11-2, . . . , 11-N which is indicated by imaging parameter information is within the scope of application of the imaging parameter used when the image is taken by each of the plurality of imaging devices 11-1, 11-2, . . . , 11-N which is a predetermined reference imaging parameter set for each of the plurality of imaging devices 11-1, 11-2, . . . , 11-N which is indicated by reference imaging parameter information.

The imaging parameter disturbance estimating unit 151 generates pieces of imaging parameter disturbance estimation information indicating whether or not there is imaging disturbance on each of the plurality of imaging devices 11-1, 11-2, . . . , 11-N which is estimated thereby, and outputs the generated pieces of imaging parameter disturbance estimation information to the imaging parameter estimation information obtaining unit 111.

The imaging parameter estimation information obtaining unit 111 obtains the pieces of imaging parameter disturbance estimation information indicating whether or not there is imaging disturbance on each of the plurality of imaging devices which is estimated by comparing the imaging parameters used when the images are taken by the respective plurality of imaging devices with the predetermined reference imaging parameters set for the respective plurality of imaging devices.

Specifically, for example, the imaging parameter estimation information obtaining unit 111 obtains the pieces of imaging parameter disturbance estimation information from the imaging parameter disturbance estimating unit 151.

By the imaging disturbance detection device 100c thus including the imaging parameter obtaining unit 131, the reference imaging parameter obtaining unit 141, and the imaging parameter disturbance estimating unit 151, even when the already installed imaging devices 11-1, 11-2, . . . , 11-N and image recording device 13 cannot generate imaging parameter disturbance estimation information, the imaging disturbance detection system 1c can be constructed.

The imaging parameter estimation information obtaining unit 111 may obtain pieces of imaging parameter disturbance estimation information generated by the respective imaging devices 11-1, 11-2, . . . , 11-N from the imaging devices 11-1, 11-2, . . . , 11-N. The imaging devices 11-1, 11-2, . . . , 11-N estimate whether or not there is imaging disturbance on their imaging devices 11-1, 11-2, . . . , 11-N by comparing imaging parameters used when images are taken by the respective plurality of imaging devices 11-1, 11-2, . . . , 11-N with predetermined reference imaging parameters set for the respective plurality of imaging devices 11-1, 11-2, . . . , 11-N. Each of the imaging devices 11-1, 11-2, . . . , 11-N generates imaging parameter disturbance estimation information indicating whether or not there is imaging disturbance, on the basis of a result of the estimation made by each of the imaging devices 11-1, 11-2, . . . , 11-N. Each of the imaging devices 11-1, 11-2, . . . , 11-N outputs the generated disturbance estimation information to the imaging disturbance detection device 100c through the communication network 12.

By each of the imaging devices 11-1, 11-2, . . . , 11-N thus generating imaging parameter disturbance estimation information, a processing load on the imaging disturbance detection device 100c can be reduced.

In addition, the imaging parameter estimation information obtaining unit 111 may obtain imaging parameter disturbance estimation information generated by the image recording device 13 from the image recording device 13. The image recording device 13 generates pieces of imaging parameter disturbance estimation information of the respective plurality of imaging devices 11-1, 11-2, . . . , 11-N by comparing imaging parameters indicated by pieces of imaging parameter information obtained from the respective plurality of imaging devices 11-1, 11-2, . . . , 11-N with predetermined reference imaging parameters set for the respective plurality of imaging devices 11-1, 11-2, . . . , 11-N and indicated by pieces of reference imaging parameter information. The image recording device 13 outputs the generated pieces of imaging parameter disturbance estimation information to the imaging disturbance detection device 100c through the communication network 12.

By the image recording device 13 thus generating imaging parameter disturbance estimation information, a processing load on the imaging disturbance detection device 100c can be reduced. In addition, by the image recording device 13 generating imaging parameter disturbance estimation information, even when the already installed imaging devices 11-1, 11-2, . . . , 11-N cannot generate imaging parameter disturbance estimation information, the imaging disturbance detection system 1c can be constructed.

Note that when the imaging parameter estimation information obtaining unit 111 obtains pieces of imaging parameter disturbance estimation information generated by the respective imaging devices 11-1, 11-2, . . . , 11-N or pieces of imaging parameter disturbance estimation information generated by the image recording device 13, in the imaging disturbance detection device 100c, the imaging parameter obtaining unit 131, the reference imaging parameter obtaining unit 141, and the imaging parameter disturbance estimating unit 151 are not essential components.

The disturbance identifying unit 160c checks which one, the presence or absence of imaging disturbance, is estimated for each of the plurality of imaging devices 11-1, 11-2, . . . , 11-N, on the basis of the pieces of imaging parameter disturbance estimation information of the respective plurality of imaging devices 11-1, 11-2, . . . , 11-N obtained by the imaging parameter estimation information obtaining unit 111 in addition to pieces of disturbance estimation information of the respective plurality of imaging devices 11-1, 11-2, . . . , 11-N obtained by the estimation information obtaining unit 110. Specifically, the disturbance identifying unit 160c checks which one, the presence or absence of imaging disturbance, is estimated for each of the plurality of imaging devices 11-1, 11-2, . . . , 11-N, on the basis of pieces of disturbance estimation information, and further checks which one, the presence or absence of imaging disturbance, is estimated for each of the plurality of imaging devices 11-1, 11-2, . . . , 11-N, on the basis of pieces of imaging parameter disturbance estimation information. For example, when the disturbance identifying unit 160c has verified that it is estimated that there is imaging disturbance on a first imaging device, i.e., a given imaging device among the plurality of imaging devices 11-1, 11-2, . . . , 11-N, on the basis of one of disturbance estimation information and imaging parameter disturbance estimation information, it is estimated that there is imaging disturbance on the first imaging device. The disturbance identifying unit 160c also estimates, for a second imaging device, i.e., an imaging device different from the first imaging device among the plurality of imaging devices 11-1, 11-2, . . . , 11-N, whether or not there is imaging disturbance on the second imaging device by the same method.

When the disturbance identifying unit 160c has verified that it is estimated that there is imaging disturbance on the first imaging device, the disturbance identifying unit 160c identifies whether or not there is imaging disturbance on the first imaging device, on the basis of which one, the presence or absence of imaging disturbance, is estimated for the second imaging device and the length of a period during which it is continuously estimated that there is imaging disturbance on the first imaging device.

The disturbance identifying unit 160c and the disturbance identifying unit 160 according to the first embodiment differ from each other in that the disturbance identifying unit 160 checks which one, the presence or absence of imaging disturbance, is estimated for each of the plurality of imaging devices 11-1, 11-2, . . . , 11-N on the basis of pieces of disturbance estimation information of the respective imaging devices 11-1, 11-2, . . . , 11-N, whereas the disturbance identifying unit 160c checks which one, the presence or absence of imaging disturbance, is estimated for each of the plurality of imaging devices 11-1, 11-2, . . . , 11-N on the basis of pieces of imaging parameter disturbance estimation information of the respective plurality of imaging devices 11-1, 11-2, . . . , 11-N in addition to pieces of disturbance estimation information of the respective imaging devices 11-1, 11-2, . . . , 11-N.

Hence, a detailed description of operations related to a function of the disturbance identifying unit 160c and corresponding with those of the disturbance identifying unit 160 is omitted.

As an example of a specific example, a case will be described in which the imaging parameter disturbance estimating unit 151 estimates whether or not there is imaging disturbance on each of the plurality of imaging devices 11-1, 11-2, . . . , 11-N by comparing an ISO sensitivity value, a shutter speed value, or an AE detection value which is an imaging parameter with a reference imaging parameter associated with the imaging parameter.

Some imaging devices such as digital still cameras or digital video cameras have a function of automatically adjusting ISO sensitivity value, shutter speed, AE, or the like, upon imaging an image in order to maintain appropriate luminance of an image to be taken. When the imaging devices 11-1, 11-2, . . . , 11-N have this function, for example, even when the luminance of an image to be taken decreases due to imaging disturbance, the imaging devices 11-1, 11-2, . . . , 11-N automatically adjust ISO sensitivity value, shutter speed, AE, or the like, so as to increase the luminance of the image to be taken.

When the imaging devices 11-1, 11-2, . . . , 11-N maintain appropriate luminance of an image to be taken by automatically adjusting ISO sensitivity value, shutter speed, AE, or the like, upon imaging the image, if imaging disturbance is detected using only the luminance of the image, then there is a possibility of a decrease in the detection accuracy of imaging disturbance.

The imaging parameter disturbance estimating unit 151 estimates that there is imaging disturbance on an imaging device whose ISO sensitivity value, shutter speed value, or AE detection value which is an imaging parameter used when an image is taken by each of the imaging devices 11-1, 11-2, . . . , 11-N is outside an appropriate range of the imaging parameter which is a reference imaging parameter. Hence, in the imaging disturbance detection device 100c, the disturbance identifying unit 160c checks which one, the presence or absence of imaging disturbance, is estimated for each of a first imaging device and a second imaging device, on the basis of imaging parameter disturbance estimation information in addition to disturbance estimation information, to identify whether or not there is imaging disturbance on the first imaging device, by which erroneous determination in detection of imaging disturbance can be restrained.

In addition, as another example of a specific example, a case will be described in which the imaging parameter disturbance estimating unit 151 estimates whether or not there is imaging disturbance on each of the plurality of imaging devices 11-1, 11-2, . . . , 11-N by comparing an AF detection value which is an imaging parameter with a reference imaging parameter associated with the imaging parameter.

Some imaging devices such as digital still cameras or digital video cameras have an AF function for maintaining an appropriate focal length on the basis of the distance to a subject to be taken.

Even when the imaging devices 11-1, 11-2, . . . , 11-N are subjected to imaging disturbance, luminance at which imaging is performed may remain high without decreasing due to light passing through an object or the like that causes the imaging disturbance, light that enters a gap between the object that causes the imaging disturbance and a lens of each of the imaging devices 11-1, 11-2, . . . , 11-N, or the like. Hence, even when the imaging devices 11-1, 11-2, . . . , 11-N are subjected to imaging disturbance, the imaging disturbance may not be able to be detected using only the luminance of a taken image.

When the imaging devices 11-1, 11-2, . . . , 11-N have the AF function, a determination can be made as to whether or not an object causing imaging disturbance is present at a point-blank range of about several centimeters from the lens of each of the imaging devices 11-1, 11-2, . . . , 11-N, using an AF detection value which is an imaging parameter used when images are taken by the imaging devices 11-1, 11-2, . . . , 11-N.

The imaging parameter disturbance estimating unit 151 estimates that there is imaging distance on an imaging device whose AF detection value which is an imaging parameter used when an image is taken by each of the imaging devices 11-1, 11-2, . . . , 11-N is outside an appropriate range of the imaging parameter which is a reference imaging parameter. Hence, in the imaging disturbance detection device 100c, the disturbance identifying unit 160c checks which one, the presence or absence of imaging disturbance, is estimated for each of a first imaging device and a second imaging device, on the basis of imaging parameter disturbance estimation information in addition to disturbance estimation information, to identify whether or not there is imaging disturbance on the first imaging device, by which erroneous determination in detection of imaging disturbance can be restrained.

Both of the above-described two specific examples are examples in which the imaging parameter disturbance estimating unit 151 estimates whether or not there is imaging disturbance on the imaging devices 11-1, 11-2, . . . , 11-N, on the basis of one imaging parameter among imaging parameters such as ISO sensitivity value, a shutter speed value, an AE detection value, and an AF detection value, but no limitation is intended thereto.

For example, the imaging parameter disturbance estimating unit 151 may estimate whether or not there is imaging disturbance on the imaging devices 11-1, 11-2, . . . , 11-N, on the basis of two or more imaging parameters among the imaging parameters such as ISO sensitivity value, a shutter speed value, an AE detection value, and an AF detection value.

Specifically, for example, when either one of results of estimation as to whether or not there is imaging disturbance on the imaging devices 11-1, 11-2, . . . , 11-N based on a first imaging parameter and results of estimation as to whether or not there is imaging disturbance on the imaging devices 11-1, 11-2, . . . , 11-N based on a second imaging parameter estimates that there is imaging disturbance on the imaging devices 11-1, 11-2, . . . , 11-N, the imaging parameter disturbance estimating unit 151 may output imaging parameter disturbance estimation information indicating that there is imaging disturbance on the imaging devices 11-1, 11-2, . . . , 11-N.

In addition, for example, when all results of estimation including results of estimation as to whether or not there is imaging disturbance on the imaging devices 11-1, 11-2, . . . , 11-N based on a first imaging parameter and results of estimation as to whether or not there is imaging disturbance on the imaging devices 11-1, 11-2, . . . , 11-N based on a second imaging parameter estimate that there is imaging disturbance on the imaging devices 11-1, 11-2, . . . , 11-N, the imaging parameter disturbance estimating unit 151 may output imaging parameter disturbance estimation information indicating that there is imaging disturbance on the imaging devices 11-1, 11-2, . . . , 11-N.

A hardware configuration of main parts of the imaging disturbance detection device 100c is the same as that described by referring to FIGS. 9A and 9B in the first embodiment, and thus, depiction and description thereof are omitted. Namely, each function of the estimation information obtaining unit 110, the image obtaining unit 120, the image luminance obtaining unit 130, the reference luminance obtaining unit 140, the disturbance estimating unit 150, the imaging parameter estimation information obtaining unit 111, the imaging parameter obtaining unit 131, the reference imaging parameter obtaining unit 141, the imaging parameter disturbance estimating unit 151, the disturbance identifying unit 160c, and the output control unit 170 may be implemented by the processor 901 and the memory 902 or may be implemented by the processing circuit 903.

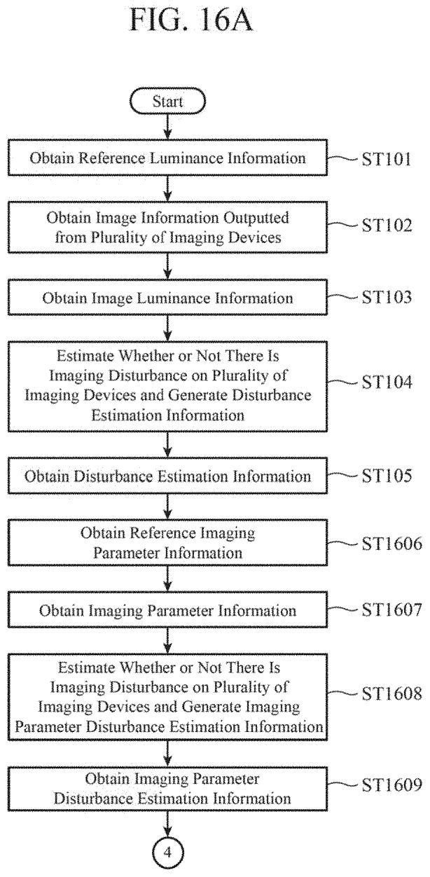

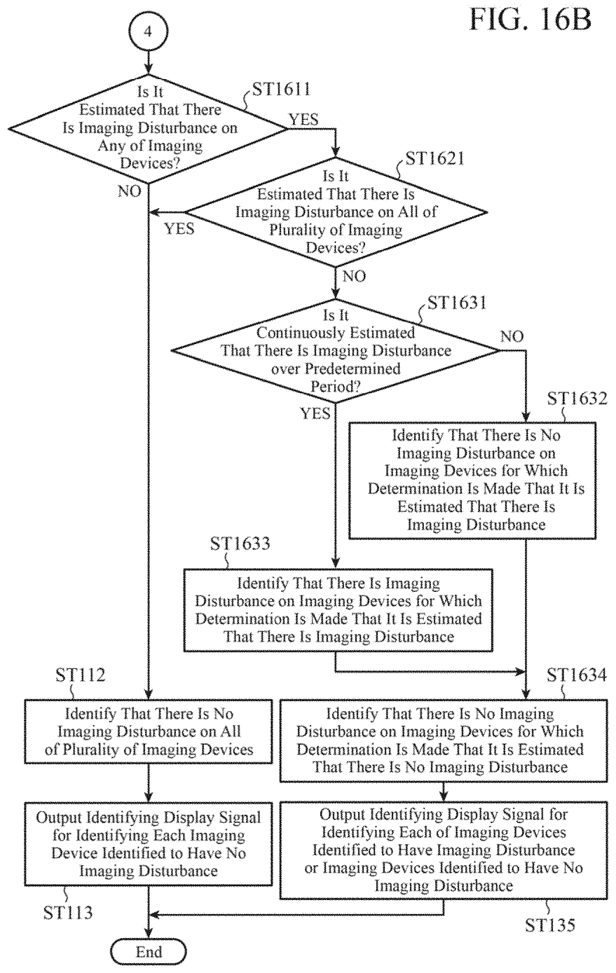

Operations of the imaging disturbance detection device 100c in the imaging disturbance detection system 1c according to the fourth embodiment will be described with reference to FIGS. 16A and 16B.

FIGS. 16A and 16B are flowcharts that describe an example of processes performed by the imaging disturbance detection device 100c in the imaging disturbance detection system 1c according to the fourth embodiment. Note that FIGS. 16A and 16B show a series of processes performed by the imaging disturbance detection device 100c. Note also that in the processes of the flowcharts shown in FIGS. 16A and 16B, the same processes as the processes of the flowchart shown in FIG. 10 are given the same reference signs and a detailed description thereof is omitted.

The imaging disturbance detection device 100c repeatedly performs the processes of the flowcharts, for example, at predetermined intervals, e.g., intervals of 15 minutes, as in the example shown in FIG. 8.

First, the imaging disturbance detection device 100c performs processes at step ST101 to ST105.

After the process at step ST105, at step ST1606, the reference imaging parameter obtaining unit 141 obtains pieces of reference imaging parameter information indicating predetermined reference imaging parameters set for the respective plurality of imaging devices 11-1, 11-2, . . . , 11-N.

Then, at step ST1607, the imaging parameter obtaining unit 131 obtains pieces of imaging parameter information indicating imaging parameters used when images are taken by the respective plurality of imaging devices 11-1, 11-2, . . . , 11-N.

Then, at step ST1608, the imaging parameter disturbance estimating unit 151 estimates whether or not there is imaging disturbance on each of the plurality of imaging devices 11-1, 11-2, . . . , 11-N by comparing the imaging parameters used when the images are taken by the respective plurality of imaging devices 11-1, 11-2, . . . , 11-N which are indicated by the pieces of imaging parameter information, with the predetermined reference imaging parameters set for the respective plurality of imaging devices 11-1, 11-2, . . . , 11-N and indicated by the pieces of reference imaging parameter information, generates pieces of imaging parameter disturbance estimation information indicating whether or not there is imaging disturbance on each of the plurality of imaging devices 11-1, 11-2, . . . , 11-N which is estimated thereby, and outputs the generated pieces of imaging parameter disturbance estimation information.

Then, at step ST1609, the imaging parameter estimation information obtaining unit 111 obtains the pieces of imaging parameter disturbance estimation information.

Then, at step ST1611, the disturbance identifying unit 160c determines whether or not it is estimated that there is imaging disturbance on any of the plurality of imaging devices 11-1, 11-2, . . . , 11-N, on the basis of the pieces of disturbance estimation information of the respective plurality of imaging devices 11-1, 11-2, . . . , 11-N and the pieces of disturbance estimation information of the respective plurality of imaging devices 11-1, 11-2, . . . , 11-N.

If the disturbance identifying unit 160c determines at step ST1611 that it is estimated that there is no imaging disturbance on all imaging devices 11-1, 11-2, . . . , 11-N among the plurality of imaging devices 11-1, 11-2, . . . , 11-N, then the imaging disturbance detection device 100c performs processes at and after step ST112.

If the disturbance identifying unit 160c determines at step ST1611 that it is estimated that there is imaging disturbance on any of the plurality of imaging devices 11-1, 11-2, . . . , 11-N, then at step ST1621, the disturbance identifying unit 160c determines whether or not it is estimated that there is imaging disturbance on all of the plurality of imaging devices 11-1, 11-2, . . . , 11-N.

If the disturbance identifying unit 160c determines at step ST1621 that it is estimated that there is imaging disturbance on all of the plurality of imaging devices 11-1, 11-2, . . . , 11-N, then the imaging disturbance detection device 100c performs processes at and after step ST112.

If the disturbance identifying unit 160c determines at step ST1621 that it is estimated that any of the plurality of imaging devices 11-1, 11-2, . . . , 11-N has no imaging disturbance, then at step ST1631, the disturbance identifying unit 160c repeatedly determines, for all imaging devices among the plurality of imaging devices 11-1, 11-2, . . . , 11-N for which the disturbance identifying unit 160c determines at step ST1611 that it is estimated that there is imaging disturbance, whether or not it is continuously estimated that there is imaging disturbance over a predetermined period, and the disturbance identifying unit 160c performs one of the following processes at step ST1632 and ST1633.

If the disturbance identifying unit 160c determines at step ST1631 that it is not continuously estimated that there is imaging disturbance over the predetermined period on the imaging devices among the plurality of imaging devices 11-1, 11-2, . . . , 11-N for which the disturbance identifying unit 160c determines at step ST1611 that it is estimated that there is imaging disturbance, then at step ST1632, the disturbance identifying unit 160c identifies that there is no imaging disturbance on the imaging devices among the plurality of imaging devices 11-1, 11-2, . . . , 11-N for which the disturbance identifying unit 160c determines at step ST1611 that it is estimated that there is imaging disturbance.

If the disturbance identifying unit 160c determines at step ST1631 that it is continuously estimated that there is imaging disturbance over the predetermined period on the imaging devices among the plurality of imaging devices 11-1, 11-2, . . . , 11-N for which the disturbance identifying unit 160c determines at step ST1611 that it is estimated that there is imaging disturbance, then at step ST1633, the disturbance identifying unit 160c identifies that there is imaging disturbance on the imaging devices among the plurality of imaging devices 11-1, 11-2, . . . , 11-N for which the disturbance identifying unit 160c determines at step ST1611 that it is estimated that there is imaging disturbance.

After step ST1632 or ST1633, at step ST1634, the disturbance identifying unit 160c identifies that there is no imaging disturbance on imaging devices among the plurality of imaging devices 11-1, 11-2, . . . , 11-N for which the disturbance identifying unit 160c determines at step ST1611 that it is estimated that there is no imaging disturbance.

After step ST1634, the imaging disturbance detection device 100c performs processes at step ST135.

Note that it may be configured that the processes at step ST101 and ST1606 are performed only once in the first series of processes when the imaging disturbance detection device 100c repeatedly performs the processes of the flowcharts at predetermined intervals.

Note also that when the estimation information obtaining unit 110 can obtain, at step ST105, disturbance estimation information from each of the plurality of imaging devices 11-1, 11-2, . . . , 11-N or an external device such as the image recording device 13, the processes at step ST101 to ST104 are not essential processes.

Note also that when at step ST1609 the imaging parameter estimation information obtaining unit 111 can obtain imaging parameter disturbance estimation information from each of the plurality of imaging devices 11-1, 11-2, . . . , 11-N or can obtain imaging parameter disturbance estimation information from an external device such as the image recording device 13, the processes at step ST1606 to ST1608 are not essential processes.

As described above, the imaging disturbance detection device 100c is configured in such a manner that the imaging disturbance detection device 100c includes the estimation information obtaining unit 110 that obtains pieces of disturbance estimation information indicating whether or not there is imaging disturbance on each of the plurality of imaging devices 11-1, 11-2, . . . , 11-N installed on the inside of the railroad car 10, which is estimated by comparing luminance of each of images taken by the plurality of imaging devices 11-1, 11-2, . . . , 11-N with predetermined reference luminance set for each of the plurality of imaging devices 11-1, 11-2, . . . , 11-N; the disturbance identifying unit 160c that identifies, when it is estimated, on the basis of the pieces of disturbance estimation information of the respective plurality of imaging devices 11-1, 11-2, . . . , 11-N obtained by the estimation information obtaining unit 110, that there is imaging disturbance on a first imaging device among the plurality of imaging devices 11-1, 11-2, . . . , 11-N, whether or not there is imaging disturbance on the first imaging device on the basis of which one, the presence or absence of imaging disturbance, is estimated for a second imaging device different from the first imaging device among the plurality of imaging devices 11-1, 11-2, . . . , 11-N, and the length of a period during which it is continuously estimated that there is imaging disturbance on the first imaging device; the output control unit 170 that outputs an identifying display signal for identifying the first imaging device identified by the disturbance identifying unit 160c to have imaging disturbance; and the imaging parameter estimation information obtaining unit 111 that obtains pieces of imaging parameter disturbance estimation information indicating whether or not there is imaging disturbance on each of the plurality of imaging devices 11-1, 11-2, . . . , 11-N which is estimated by comparing imaging parameters used when images are taken by the respective plurality of imaging devices 11-1, 11-2, . . . , 11-N with predetermined reference imaging parameters set for the respective plurality of imaging devices 11-1, 11-2, . . . , 11-N, and when it is estimated that there is imaging disturbance on the first imaging device among the plurality of imaging devices 11-1, 11-2, . . . , 11-N, on the basis of the pieces of imaging parameter disturbance estimation information of the respective plurality of imaging devices 11-1, 11-2, . . . , 11-N obtained by the imaging parameter estimation information obtaining unit 111, in addition to the pieces of disturbance estimation information of the respective plurality of imaging devices 11-1, 11-2, . . . , 11-N obtained by the estimation information obtaining unit 110, the disturbance identifying unit 160c identifies whether or not there is imaging disturbance on the first imaging device on the basis of which one, the presence or absence of imaging disturbance, is estimated for the second imaging device different from the first imaging device among the plurality of imaging devices 11-1, 11-2, . . . , 11-N, and the length of a period during which it is continuously estimated that there is imaging disturbance on the first imaging device.

By such a configuration, the imaging disturbance detection device 100c can accurately determine whether or not the imaging devices 11-1, 11-2, . . . , 11-N installed in the railroad car 10 are in an imaging abnormal state. Particularly, by such a configuration, the imaging disturbance detection device 100c can estimate whether or not there is imaging disturbance on each of the plurality of imaging devices 11-1, 11-2, . . . , 11-N on the basis of not only the luminance of images taken by the respective plurality of imaging devices 11-1, 11-2, . . . , 11-N, but also imaging parameters used when the images are taken.

In addition, the imaging disturbance detection device 100c is configured in such a manner that the imaging disturbance detection device 100c includes, in addition to the above-described components, the image luminance obtaining unit 130 that obtains pieces of image luminance information indicating luminance of each of images taken by the plurality of imaging devices 11-1, 11-2, . . . , 11-N; the reference luminance obtaining unit 140 that obtains pieces of reference luminance information indicating predetermined reference luminance set for each of the plurality of imaging devices 11-1, 11-2, . . . , 11-N; and the disturbance estimating unit 150 that estimates whether or not there is imaging disturbance on each of the plurality of imaging devices 11-1, 11-2, . . . , 11-N by comparing the luminance of each image indicated by the pieces of image luminance information obtained by the image luminance obtaining unit 130 with the predetermined reference luminance set for each of the plurality of imaging devices 11-1, 11-2, . . . , 11-N and indicated by the pieces of reference luminance information obtained by the reference luminance obtaining unit 140, and outputs pieces of disturbance estimation information indicating whether or not there is imaging disturbance on each of the plurality of imaging devices 11-1, 11-2, . . . , 11-N which is estimated thereby, and the estimation information obtaining unit 110 obtains the pieces of disturbance estimation information from the disturbance estimating unit 150.

By such a configuration, even when the imaging devices 11-1, 11-2, . . . , 11-N installed in the railroad car 10 cannot generate disturbance estimation information, the imaging disturbance detection device 100c can generate disturbance estimation information.

In addition, the imaging disturbance detection device 100c is configured in such a manner that the imaging disturbance detection device 100c includes, in addition to the above-described components, a parameter obtaining unit that obtains pieces of parameter information indicating imaging parameters used when images are taken by the respective plurality of imaging devices 11-1, 11-2, . . . , 11-N; a reference parameter obtaining unit that obtains pieces of reference parameter information indicating predetermined reference imaging parameters set for the respective plurality of imaging devices 11-1, 11-2, . . . , 11-N; and the imaging parameter disturbance estimating unit 151 that estimates whether or not there is imaging disturbance on each of the plurality of imaging devices 11-1, 11-2, . . . , 11-N by comparing the imaging parameters used when the images are taken by the respective plurality of imaging devices 11-1, 11-2, . . . , 11-N which are indicated by the pieces of parameter information obtained by the parameter obtaining unit, with the predetermined reference imaging parameters set for the respective plurality of imaging devices 11-1, 11-2, . . . , 11-N and indicated by the pieces of reference parameter information obtained by the reference parameter obtaining unit, and outputs pieces of imaging parameter disturbance estimation information indicating whether or not there is imaging disturbance on each of the plurality of imaging devices 11-1, 11-2, . . . , 11-N which is estimated thereby, and the imaging parameter estimation information obtaining unit 111 obtains the pieces of imaging parameter disturbance estimation information from the imaging parameter disturbance estimating unit 151.

By such a configuration, even when the imaging devices 11-1, 11-2, . . . , 11-N installed in the railroad car 10 cannot generate imaging parameter disturbance estimation information, the imaging disturbance detection device 100c can generate imaging parameter disturbance estimation information.

In addition, the imaging disturbance detection device 100c may include, in addition to the above-described components, the time mode switching unit 180 that is included in the imaging disturbance detection device 100a according to the second embodiment and that switches, on the basis of time information indicating a current time, between two operating modes: a disturbance detection mode in which whether or not there is imaging disturbance is detected for each of the plurality of imaging devices 11-1, 11-2, . . . , 11-N, and a detection pause mode in which whether or not there is imaging disturbance is not detected for each of the plurality of imaging devices 11-1, 11-2, . . . , 11-N.

As described in the second embodiment, the time mode switching unit 180, for example, switches between the operating modes so that operations are performed in the detection pause mode during a time period during which there is influence of sunlight when each of the plurality of imaging devices 11-1, 11-2, . . . , 11-N performs imaging, and switches between the operating modes so that operations are performed in the disturbance detection mode during a time period during which there is no influence of sunlight when each of the plurality of imaging devices 11-1, 11-2, . . . , 11-N performs imaging, on the basis of time period information in which time periods during which there is influence of sunlight when each of the plurality of imaging devices 11-1, 11-2, . . . , 11-N performs imaging are determined in advance, and time information.

In addition, the imaging disturbance detection device 100c may include, in addition to the above-described components, the location mode switching unit 181 that is included in the imaging disturbance detection device 100a according to the second embodiment and that switches, on the basis of location information indicating a location through which the railroad car 10 travels, between two operating modes: a disturbance detection mode in which whether or not there is imaging disturbance is detected for each of the plurality of imaging devices 11-1, 11-2, . . . , 11-N, and a detection pause mode in which whether or not there is imaging disturbance is not detected for each of the plurality of imaging devices 11-1, 11-2, . . . , 11-N.

As described in the second embodiment, the location mode switching unit 181, for example, switches between the operating modes so that operations are performed in the detection pause mode when the railroad car 10 travels through a location where there is influence of sunlight when each of the plurality of imaging devices 11-1, 11-2, . . . , 11-N performs imaging, and switches between the operating modes so that operations are performed in the disturbance detection mode when the railroad car 10 travels through a location where there is no influence of sunlight when each of the plurality of imaging devices 11-1, 11-2, . . . , 11-N performs imaging, on the basis of location influence information in which information indicating each of a plurality of locations on a route that the railroad car 10 travels is associated in advance with information indicating whether or not there is influence of sunlight when each of the plurality of imaging devices 11-1, 11-2, . . . , 11-N performs imaging at each location, and location information.

In addition, the imaging disturbance detection device 100c may be configured in such a manner that the imaging disturbance detection device 100c includes, in addition to the above-described components, the information providing unit 190 and the another device's estimation information obtaining unit 191 that are included in the imaging disturbance detection device 100b according to the third embodiment, and the information providing unit 190 provides pieces of disturbance estimation information obtained by the estimation information obtaining unit 110, as pieces of another device's disturbance estimation information, to other imaging disturbance detection devices 100c, the another device's estimation information obtaining unit 191 obtains pieces of another device's disturbance estimation information provided from other imaging disturbance detection devices 100c, and the disturbance identifying unit 160c may be configured to identify, for all imaging devices 11-1, 11-2, . . . , 11-N, whether or not there is imaging disturbance on the basis of the pieces of another device's disturbance estimation information obtained by the another device's estimation information obtaining unit 191, when it is estimated, on the basis of the pieces of disturbance estimation information obtained by the estimation information obtaining unit 110 and the pieces of imaging parameter disturbance estimation information obtained by the imaging parameter estimation information obtaining unit 111, that there is imaging disturbance on all imaging devices 11-1, 11-2, . . . , 11-N among the plurality of imaging devices 11-1, 11-2, . . . , 11-N upon identifying whether or not there is imaging disturbance on a first imaging device on the basis of the pieces of imaging parameter disturbance estimation information in addition to the pieces of disturbance estimation information.

Furthermore, the information providing unit 190 may be modified to provide imaging parameter disturbance estimation information obtained by the imaging parameter estimation information obtaining unit 111, in addition to the disturbance estimation information, to other imaging disturbance detection devices 100c in such a manner that the obtained imaging parameter disturbance estimation information is included in another device's disturbance estimation information, and the disturbance identifying unit 160c may be configured to identify, for all imaging devices 11-1, 11-2, . . . , 11-N, whether or not there is imaging disturbance on the basis of the pieces of another device's disturbance estimation information obtained by the another device's estimation information obtaining unit 191, when it is estimated, on the basis of the pieces of disturbance estimation information obtained by the estimation information obtaining unit 110 and pieces of imaging parameter disturbance estimation information obtained by the imaging parameter estimation information obtaining unit 111, that there is imaging disturbance on all imaging devices 11-1, 11-2, . . . , 11-N among the plurality of imaging devices 11-1, 11-2, . . . , 11-N upon identifying whether or not there is imaging disturbance on a first imaging device on the basis of the pieces of imaging parameter disturbance estimation information in addition to the pieces of disturbance estimation information.

The another device's estimation information obtaining unit 191, for example, obtains pieces of another device's disturbance estimation information from an imaging disturbance detection device 100c that identifies whether or not there is imaging disturbance on a plurality of imaging devices 11-1, 11-2, . . . , 11-N installed on the inside of another railroad car 10 in a train to which is connected the railroad car 10 having installed therein the plurality of imaging devices 11-1, 11-2, . . . , 11-N corresponding to pieces of disturbance estimation information obtained by the estimation information obtaining unit 110, the another railroad car 10 being different from the railroad car 10.

Note that the invention is not limited to being applied to the railroad cars 10, and can be applied to vehicles such as large buses or buildings such as houses.

Note also that in the invention, a free combination of the embodiments, modifications to any component of each of the embodiments, or omissions of any component in each of the embodiments are possible within the scope of the invention.

### INDUSTRIAL APPLICABILITY

An imaging disturbance detection device according to the invention can be applied to an imaging disturbance detection system. In addition, the imaging disturbance detection device according to the invention is not limited to being applied to railroad cars, and can be applied to vehicles such as large buses or buildings such as houses.

### REFERENCE SIGNS LIST

1, 1a, 1b, 1c: imaging disturbance detection system,
10, 10-1, . . . , 10-m, . . . , 10-M: railroad car,
11-1, 11-2, . . . , 11-N, 11-1-1, 11-2-1, . . . , 11-N-1, 11-1-m, 11-2-m, . . . , 11-N-m, 11-1-M, 11-2-M, . . . , 11-N-M: imaging device,
12: communication network,
13: image recording device,
14: display device,
14-1, 14-2, 14-3, 14-4: light-emitting element,
100, 100a, 100b, 100b-1, 100b-2, . . . , 100b-M, 100c: imaging disturbance detection device,
110: estimation information obtaining unit,
111: imaging parameter estimation information obtaining unit,
120: image obtaining unit,
130: image luminance obtaining unit,
131: imaging parameter obtaining unit,
140: reference luminance obtaining unit,
141: reference imaging parameter obtaining unit,
150: disturbance estimating unit,
151: imaging parameter disturbance estimating unit,
160, 160b, 160c: disturbance identifying unit,
170: output control unit,
180: time mode switching unit,
181: location mode switching unit,
190: information providing unit,
191: another device's estimation information obtaining unit,
901: processor,
902: memory, and
903: processing circuit

1. An imaging disturbance detection device comprising:
processing circuitry
to obtain pieces of disturbance estimation information indicating whether or not there is imaging disturbance on each of a plurality of imaging devices installed on inside of a railroad car, an estimation as to whether or not there is imaging disturbance on each of the plurality of imaging devices being made by comparing luminance of each of images taken by the plurality of imaging devices with predetermined reference luminance set for each of the plurality of imaging devices;
to identify, when it is estimated, on a basis of the pieces of disturbance estimation information of the respective plurality of imaging devices, that there is imaging disturbance on a first imaging device among the plurality of imaging devices, whether or not there is imaging disturbance on the first imaging device on a basis of which one, presence or absence of imaging disturbance, is estimated for a second imaging device different from the first imaging device among the plurality of imaging devices, and a length of a period during which it is continuously estimated that there is imaging disturbance on the first imaging device, and
to output an identifying display signal for identifying the first imaging device to have imaging disturbance.

2. The imaging disturbance detection device according to claim 1, wherein
the processing circuitry obtains pieces of image luminance information indicating the luminance of each of the images taken by the plurality of imaging devices,
obtains pieces of reference luminance information indicating the predetermined reference luminance set for each of the plurality of imaging devices, and
estimates whether or not there is imaging disturbance on each of the plurality of imaging devices by comparing the luminance of each of the images indicated by the pieces of image luminance information with the predetermined reference luminance set for each of the plurality of imaging devices and indicated by the pieces of reference luminance information, and outputs pieces of disturbance estimation information indicating whether or not there is imaging disturbance on each of the plurality of imaging devices,
obtains the pieces of disturbance estimation information.

3. The imaging disturbance detection device according to claim 1, wherein the processing circuitry obtains pieces of imaging parameter disturbance estimation information indicating whether or not there is imaging disturbance on each of the plurality of imaging devices, an estimation as to whether or not there is imaging disturbance on each of the plurality of imaging devices being made by comparing imaging parameters used when images are taken by the respective plurality of imaging devices with predetermined reference imaging parameters set for the respective plurality of imaging devices, wherein
when it is estimated that there is imaging disturbance on the first imaging device among the plurality of imaging devices, on a basis of the pieces of imaging parameter disturbance estimation information of the respective plurality of imaging devices, in addition to the pieces of disturbance estimation information of the respective plurality of imaging devices, identifies whether or not there is imaging disturbance on the first imaging device on a basis of which one, presence or absence of imaging disturbance, is estimated for the second imaging device different from the first imaging device among the plurality of imaging devices, and a length of a period during which it is continuously estimated that there is imaging disturbance on the first imaging device.

4. The imaging disturbance detection device according to claim 3, wherein
the processing circuitry obtains pieces of imaging parameter information indicating the imaging parameters used when the images are taken by the respective plurality of imaging devices,
obtains pieces of reference imaging parameter information indicating the predetermined reference imaging parameters set for the respective plurality of imaging devices, and
estimates whether or not there is imaging disturbance on each of the plurality of imaging devices by comparing the imaging parameters used when the images are taken by the respective plurality of imaging devices with the predetermined reference imaging parameters set for the respective plurality of imaging devices and indicated by the pieces of reference imaging parameter information, and outputs pieces of imaging parameter disturbance estimation information indicating whether or not there is imaging disturbance on each of the plurality of imaging devices, the imaging parameters being indicated by the pieces of imaging parameter information, wherein
the processing circuitry obtains the pieces of imaging parameter disturbance estimation information.

5. The imaging disturbance detection device according to claim 1, wherein the processing circuitry switches, on a basis of time information indicating a current time, between two operating modes including a disturbance detection mode in which whether or not there is imaging disturbance is detected for each of the plurality of imaging devices, and a detection pause mode in which whether or not there is imaging disturbance is not detected for each of the plurality of imaging devices.

6. The imaging disturbance detection device according to claim 5, wherein the processing circuitry switches between the operating modes so that operations are performed in the detection pause mode during a time period during which there is influence of sunlight when each of the plurality of imaging devices performs imaging, and switches between the operating modes so that operations are performed in the disturbance detection mode during a time period during which there is no influence of sunlight when each of the plurality of imaging devices performs imaging, on a basis of time period information in which time periods during which there is influence of sunlight when each of the plurality of imaging devices performs imaging are determined in advance, and the time information.

7. The imaging disturbance detection device according to claim 1, wherein the processing circuitry switches, on a basis of location information indicating a location through which the railroad car travels, between two operating modes including a disturbance detection mode in which whether or not there is imaging disturbance is detected for each of the plurality of imaging devices, and a detection pause mode in which whether or not there is imaging disturbance is not detected for each of the plurality of imaging devices.

8. The imaging disturbance detection device according to claim 7, wherein the processing circuitry switches between the operating modes so that operations are performed in the detection pause mode when the railroad car travels through a location where there is influence of sunlight when each of the plurality of imaging devices performs imaging, and switches between the operating modes so that operations are performed in the disturbance detection mode when the railroad car travels through a location where there is no influence of sunlight when each of the plurality of imaging devices performs imaging, on a basis of location influence information in which information indicating each of a plurality of locations on a route that the railroad car travels is associated in advance with information indicating whether or not there is influence of sunlight when each of the plurality of imaging devices performs imaging at each of the locations, and the location information.

9. The imaging disturbance detection device according to claim 1, wherein the processing circuitry provides the pieces of disturbance estimation information, as pieces of another device's disturbance estimation information, to another imaging disturbance detection device, and
obtains pieces of another device's disturbance estimation information provided from the another imaging disturbance detection device, wherein
when it is estimated, on a basis of the pieces of disturbance estimation information, that there is imaging disturbance on all imaging devices among the plurality of imaging devices upon identifying whether or not there is imaging disturbance on the first imaging device on a basis of the pieces of disturbance estimation information, the processing circuitry identifies, for all imaging devices, whether or not there is imaging disturbance on a basis of the pieces of another device's disturbance estimation information.

10. The imaging disturbance detection device according to claim 9, wherein the processing circuitry obtains the pieces of another device's disturbance estimation information from an imaging disturbance detection device that identifies whether or not there is imaging disturbance on a plurality of imaging devices installed on inside of another railroad car in a train to which is connected the railroad car in which are installed the plurality of imaging devices corresponding to the pieces of disturbance estimation information, the another railroad car being different from the railroad car.

11. An imaging disturbance detection system comprising:
a plurality of imaging devices installed on inside of a railroad car;
an imaging disturbance detection device according to claim 1; and
a display device for displaying an identifying display signal outputted from an imaging disturbance detection device.

12. An imaging disturbance detection system comprising:
a plurality of imaging devices installed on inside of each of a plurality of railroad cars in a train having the plurality of railroad cars connected to each other;
a plurality of imaging disturbance detection devices according to claim 9; and
a display device for displaying identifying display signals outputted from the plurality of imaging disturbance detection devices.

13. An imaging disturbance detection method comprising:
obtaining pieces of disturbance estimation information indicating whether or not there is imaging disturbance on each of a plurality of imaging devices installed on inside of a railroad car, an estimation as to whether or not there is imaging disturbance on each of the plurality of imaging devices being made by comparing luminance of each of images taken by the plurality of imaging devices with predetermined reference luminance set for each of the plurality of imaging devices;
identifying, when it is estimated, on a basis of the pieces of disturbance estimation information of the respective plurality of imaging devices, that there is imaging disturbance on a first imaging device among the plurality of imaging devices, whether or not there is imaging disturbance on the first imaging device on a basis of which one, presence or absence of imaging disturbance, is estimated for a second imaging device different from the first imaging device among the plurality of imaging devices, and a length of a period during which it is continuously estimated that there is imaging disturbance on the first imaging device; and
outputting an identifying display signal for identifying the first imaging device to have imaging disturbance.
